(19) United States
(12) Patent Application Publication
(10) Pub. No.: US 2017/0060966 A1
(43) Pub. Date: Mar. 2, 2017

(54) Action Recommendation System For Focused Objects

(71) Applicant: Quixey, Inc., Mountain View, CA (US)

(72) Inventors: Eric GLOVER, Palo Alto, CA (US); Jonathan BEN-TZUR, Sunnyvale, CA (US)

(73) Assignee: Quixey, Inc., Mountain View, CA (US)

(21) Appl. No.: 15/244,436

(22) Filed: Aug. 23, 2016

Related U.S. Application Data
(63) Continuation of application No. 14/836,907, filed on Aug. 26, 2015.

(51) Int. Cl. G06F 17/30

(52) U.S. Cl. CPC G06F 17/30554; G06F 17/3053; G06F 17/3056

(57) ABSTRACT

An apparatus includes a user interface module that displays a search user interface element to a user. The search element is associated with a multimedia object. An object type module determines type data for the multimedia object indicating an object type of the multimedia object. A query wrapper construction module creates a query wrapper based on the type data. A network communication module transmits the query wrapper to a search system and receives a result set. The result set includes identifying information of a first application state of a first application and a first access mechanism for the first application state. A result presentation module presents the result set to the user. An access module, in response to actuation of a first user interface element, opens the first application to the first application state according to the first access mechanism and provides the multimedia object to the first application state.

### CROSS-REFERENCE TO RELATED APPLICATIONS

The present application is a continuation of U.S. patent application Ser. No. 14/836,907 filed on Aug. 26, 2015. The entire disclosure of the application referenced above is incorporated by reference.

### FIELD

The present disclosure relates to computer search systems and more particularly to computer search systems for relevant application states.

### BACKGROUND

Applications can perform a variety of different actions for a user. As one example, a restaurant reservation application can make reservations for restaurants. As another example, an internet media player application can stream media (e.g., a song or movie) from the Internet. Some applications can perform more than one action. As one example, a restaurant reservation application may allow a user to retrieve information about a restaurant and read user reviews for the restaurant in addition to making restaurant reservations. As another example, an internet media player application may allow a user to perform searches for digital media and generate music playlists in addition to streaming media from the Internet.

An application state of an application may refer to a “screen” within the application. In general, an application state may refer to a configuration of an application in which the application displays content to the user, such as information related to one or more products, services, or vendors provided by, or accessible via, the application. An application state may also refer to a function provided by an application. As one example, an application state of an online shopping application may correspond to a screen of the application that describes (e.g., using text and/or image data) a particular product or service sold through the application (e.g., by one or more vendors associated with the application).

As another example, an application state of a music player application may correspond to a screen of the application that describes (e.g., using text and/or image data) a particular song that the application may play to a user (e.g., by displaying a name of the song, the album, and/or the musical artist).

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An apparatus includes a user interface module, an object type determination module, a query wrapper construction module, a network communication module, a result presentation module, and an access module. The user interface module is configured to selectively display a search user interface element to a user of the apparatus. The search user interface element is associated with a multimedia object being presented to the user. The object type determination module is configured to determine type data for the multimedia object. The type data indicates an object type of the multimedia object. The query wrapper construction module is configured to create a query wrapper based on the type data. The network communication module is configured to transmit the query wrapper to a search system and receive a result set from the search system. The result set includes (i) identifying information of a first application state of a first application and (ii) a first access mechanism for the first application state. The identifying information includes at least one of text and an image. The result presentation module is configured to, in response to actuation by the user of the search user interface element, present the result set to the user. The presentation includes (i) presenting the identifying information corresponding to the first application state and (ii) presenting a first user interface element corresponding to the first application state. The access module is configured to, in response to actuation of the first user interface element by the user, (i) open the first application to the first application state according to the first access mechanism and (ii) provide the multimedia object to the first application state.

In other features, the type data includes one of (i) an Internet Assigned Numbers Authority media type and (ii) a MIME (Multipurpose Internet Mail Extensions) type. In other features, the object type determination module is configured to determine type data for the multimedia object based on at least one of an extension of the multimedia object and a header region of the multimedia object. In other features, the object type determination module is configured to set the type data for the multimedia object equal to an extension of the multimedia object.

In other features, the apparatus includes a focus identification module configured to determine whether the multimedia object is a focus of the user, and direct the user interface module to display the search user interface element in response to determining that the multimedia object is the focus of the user. In other features, the user interface module is configured to display search user interface elements each respectively associated with a plurality of multimedia objects. The focus identification module is configured to determine that the multimedia object is the focus of the user in response to user actuation of the search user interface element associated with the multimedia object. In other features, the focus identification module is configured to selectively determine that the multimedia object is the focus of the user in response to the multimedia object occupying more than a predetermined percentage of a screen of the apparatus.

In other features, the focus identification module is configured to determine that the multimedia object is not the focus of the user in response to more than a second predetermined percentage of the multimedia object not being presently visible to the user. In other features, the object type determination module is configured to determine the type data for the multimedia object after actuation by the user of the search user interface element. In other features, the access module is configured to, in response to the first access mechanism being a web access mechanism, upload the multimedia object to a web server hosting the first application state.

In other features, the access module is configured to, in response to the first access mechanism being a native access mechanism, provide a location reference of the multimedia object to the first application state of the first application executing on the apparatus. In other features, the apparatus includes a file management module configured to create a copy of the multimedia object prior to providing the multimedia object to the first application state. In other features, the file management module is configured to overwrite the multimedia object with the copy in response to an indication by the user that a modification made to the multimedia object was unwanted.

In other features, the result set includes (i) identifying information of a second application state of a second application and (ii) a second access mechanism for the second application state. The access module is configured to, subsequent to modification of the multimedia object by the first application state and in response to actuation of a second user interface element by the user, (i) open the second application to the second application state according to the second access mechanism and (ii) provide the modified multimedia object to the second application state.

In other features, the apparatus includes an installed application data store that tracks apps installed on the apparatus. The query wrapper construction module is configured to include information from the installed application data store in the query wrapper. In other features, the apparatus includes an active account data store that tracks accounts registered with an operating system of the apparatus. The query wrapper construction module is configured to include information from the active account data store in the query wrapper.

A search system includes a set generation module, a set processing module, and a results generation module. The set generation module is configured to, in response to receiving a query from a user device, select a set of records from a plurality of records stored in a search data store. Each record of the plurality of records corresponds to an application. The query includes information identifying a first object type. The set generation module is configured to select the set of records such that each record of the set of records includes metadata specifying an ability of the corresponding application to handle objects of the first object type. The set processing module is configured to assign a score to each record of the set of records. The set processing module is configured to increase the score of a first record of the set of records in response to the metadata for the first record indicating higher certainty that the application corresponding to the first record is able to handle the first object type. The results generation module is configured to transmit a results data structure to the user device. The results data structure includes entries corresponding to records from the set of records that were assigned highest scores. Each entry of the results data structure includes an access mechanism configured to allow a user of the user device to access the respective application.

In other features, each record of the plurality of records corresponds to a state of an application. For each entry of the results data structure, the access mechanism is configured to allow the user of the user device to access a respective state of the respective application. In other features, each record of the set of records includes metadata specifying the ability of the respective state of the respective application to handle the first object type. In other features, the query includes an indication of a first action the user of the user device desires to perform on a first object having the first object type. The set generation module is configured to select the set of records such that each record of the set of records includes metadata indicating an ability of the respective state of the respective application to perform the first action.

In other features, the query includes an indication of a first action the user of the user device desires to perform on a first object having the first object type. The set generation module is configured to select the set of records such that each record of the set of records includes metadata indicating an ability of the respective application to perform the first action. In other features, the query includes a text string identifying the first action. The set processing module is configured to calculate the score of the first record based on a term frequency-inverse document frequency comparison of the text string to text metadata of the first record.

In other features, the search system includes a query analysis module configured to parse the text string into tokens. The set processing module is configured to calculate the score of the first record based on a term frequency-inverse document frequency comparison of the tokens to text metadata of the first record. In other features, the first object type specifies one of (i) an Internet Assigned Numbers Authority media type and (ii) a MIME (Multipurpose Internet Mail Extensions) type. In other features, the search system includes an object type mapping module configured to map from a first domain to a second domain. The first domain includes a list of object types provided by queries. The second domain includes a list of object types recognized by the search data store.

In other features, the search system includes an object type mapping module configured to determine the first object type based on at least one of an extension of an object and a header region of the object. The query includes the at least one of the extension of the object and the header region of the object. In other features, the query includes information regarding at least one of applications installed on the user device and user accounts active on the user device. The set processing module is configured to at least one of (i) increase the score of the first record in response to the information indicating that the application corresponding to the first record is installed on the user device and (ii) increase the score of the first record in response to the information indicating that one of the user accounts active on the user device is associated with the application corresponding to the first record.

An apparatus includes a user interface module, an object type determination module, a query wrapper construction module, a network communication module, a result presentation module, and an access module. The user interface module is configured to selectively display a search user interface element to a user of the apparatus. The search user interface element is associated with a multimedia object being presented to the user. The object type determination module is configured to determine type data for the multimedia object. The type data indicates an object type of the multimedia object. The query wrapper construction module is configured to create a query wrapper based on the type data. The network communication module is configured to transmit the query wrapper to a search system and receive a result set from the search system. The result set includes (i) identifying information of a first application and (ii) a first access mechanism for the first application. The identifying information includes at least one of text and an image. The result presentation module is configured to, in response to actuation by the user of the search user interface element, present the result set to the user. The presentation includes presenting the identifying information corresponding to the first application and presenting a first user interface element corresponding to the first application. The access module is configured to, in response to actuation of the first user interface element by the user, (i) open the first application and (ii) provide the multimedia object to the first application.

A method of operating a user device includes selectively displaying a search user interface element to a user of the apparatus. The search user interface element is associated with a multimedia object being presented to the user. The method includes determining type data for the multimedia object. The type data indicates an object type of the multimedia object. The method includes creating a query wrapper based on the type data. The method includes transmitting the query wrapper to a search system and receiving a result set from the search system. The result set includes (i) identifying information of a first application state of a first application and (ii) a first access mechanism for the first application state. The identifying information includes at least one of text and an image. The method includes, in response to actuation by the user of the search user interface element, presenting the result set to the user. The presenting includes (i) presenting the identifying information corresponding to the first application state and (ii) presenting a first user interface element corresponding to the first application state. The method includes, in response to actuation of the first user interface element by the user, (i) opening the first application to the first application state according to the first access mechanism and (ii) providing the multimedia object to the first application state.

A method of operating a user device includes selectively displaying a search user interface element to a user of the apparatus. The search user interface element is associated with a multimedia object being presented to the user. The method includes determining type data for the multimedia object. The type data indicates an object type of the multimedia object. The method includes creating a query wrapper based on the type data. The method includes transmitting the query wrapper to a search system and receiving a result set from the search system. The result set includes (i) identifying information of a first application and (ii) a first access mechanism for the first application. The identifying information includes at least one of text and an image. The method includes, in response to actuation by the user of the search user interface element, presenting the result set to the user. The presenting includes presenting the identifying information corresponding to the first application and presenting a first user interface element corresponding to the first application. The method includes, in response to actuation of the first user interface element by the user, (i) opening the first application and (ii) providing the multimedia object to the first application.

In other features, a non-transitory computer-readable medium stores instructions, where the instructions cause processor hardware to perform one or more of the above methods.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a combined functional block diagram and graphical user interface example according to the principles of the present disclosure.

FIGS. 2A-2F are example graphical user interfaces according to the principles of the present disclosure invoked in a sequence by hypothetical user interaction.

FIGS. 3A and 3B are additional example graphical user interfaces according to the principles of the present disclosure.

FIG. 4 is a graphical depiction of an excerpt of an example action ontology.

FIG. 5 is a high-level functional block diagram of the search system in an application ecosystem.

FIGS. 6A-6C are graphical depictions of example contents of query wrappers sent to a search system.

FIGS. 7A-7C are graphical depictions of example contents of results messages returned in response to a query wrapper.

FIG. 8 is a high-level block diagram of an example search system and representative data sources mined by the search system.

FIG. 9A is a graphical representation of an example app state record format.

FIG. 9B is a graphical representation of an example app state record according to the format of FIG. 9A.

FIG. 10A is a graphical representation of an example app record format.

FIG. 10B is a graphical representation of an example app record according to the format of FIG. 10A.

FIG. 11 is a functional block diagram of an example implementation of a search client.

FIG. 12 is a functional block diagram of an example implementation of a search system.

FIG. 13 is a flowchart of example operation of a search client.

FIGS. 14A-14B together are a flowchart of example operation of a search system.

In the drawings, reference numbers may be reused to identify similar and/or identical elements.

### DETAILED DESCRIPTION

### Introduction

When a user of a computing device (such as a smartphone) is viewing an object, there may be a number of actions the user may want to take with respect to that object. For example, the object may be a multimedia object, such as a picture, video, or document. The object may instead be listened to, such as a voice message, or the object may have both audio and visual components, such as a music video.

In addition to actions that the user envisions taking with respect to the object, there may be other actions that would be beneficial to the user but had not occurred to the user. To assist the user in performing these foreseen and unforeseen actions, a user interface element may be displayed along with the object. The user interface element may indicate that a menu, pop-up window, or alternative window can be accessed that will provide a choice of actions, apps that can perform those actions, and/or app states at which those actions can be performed, all of which are relevant to the object of interest.

This user interface element may be integrated into an app by the app developer. For example only, the developer of an image viewing app may integrate such a user interface element to provide additional functionality beyond the viewing capabilities of the image viewing app. The user interface element allows other actions, such as editing the image or sharing the image, to be offered to the user without any substantial additional work on the part of the developer.

In other implementations, a search client may be installed on the computing device, which operates to overlay a user interface element on the apps of other developers. For example, an installed search client may overlay a user interface element on each state of another app when the other app is displaying a multimedia object. The search client can thereby extend the functionality of a variety of apps from a variety of different developers.

The search client may be programmed to make the user interface element visible only when the multimedia object appears to be the focus of the user's attention. If only a single multimedia object is visible or audible, the determination of focus is straightforward. If multiple multimedia objects are visible or audible, then a further determination may be made regarding which multimedia object has the focus. While the present disclosure applies to any perceptible object, for simplicity the following discussion will use language that corresponds to visible multimedia objects. For some other objects not generally visible, like audio objects, the term “visible” may refer to a representation of the object, such as an icon, a song name within a playlist, or a filename.

Focus information may be measured directly using technology such as eye movement tracking, the details of which are beyond the scope of this disclosure. Absent any direct information about what the user is looking at, focus on a multimedia object may be inferred based on a size and placement of the multimedia object. For example, a multimedia object occupying more than a predetermined percentage of the screen of the user device (such as 60%, as one example) may be inferred to be the focus of the user.

Other indicators may also suggest what the user's focus is on. For example, if more than a predetermined percentage (such as 40%, as one example) of a multimedia object is presently not displayed, such as when the user has scrolled away from the image in a web page, that multimedia object may be assumed to not be the focus. A position of the user's hand may also indicate focus.

For example, if a user's finger is hovering over, or touching, a region of the screen where a multimedia object is displayed, that multimedia object may be the focus of the user's attention. For some objects, such as a 3D object, only one view or representation of the object may be visible. Therefore, the object may be identified by the user selecting a containing area within which a representation of the object is shown. The multimedia object may be referred to more generally as a data object, which may also include objects such as restaurant records.

When the search client identifies a multimedia object that is likely the focus of the user, the user interface element may be superimposed on top of the multimedia object. The user interface element may include an image of a magnifying glass or some other indicator, such as an ellipsis, which indicate that additional data or options are available. When the user actuates this user interface element, a search may be sent to a search system with parameters describing the focused multimedia object. In other implementations, search results for visible objects, or for common types of objects, may be cached by the search client so that results can immediately be provided to the user upon actuation of the user interface element.

For example, an object type of the focused multimedia object may be provided to the search system. In this way, results from the search system can be tailored to those apps or app states that are capable of, or at least might be capable of, handling the multimedia object in question. The search system may provide a list of apps that provide functionality for the multimedia object. Additionally or alternatively, the search system may provide app states allowing the user to link directly into a page (state) of an app that performs one or more actions. The search system thereby allows the user to quickly identify installed apps that can perform actions of interest, as well as find new apps and new actions of interest.

The search client may overlay the user interface element on any other native application or on a selected set of applications or application categories. The search client may also overlay a user interface element onto pages of a web browser, whether the web browser is built-in to an operating system of the user device or is an alternative browser.

Overlaying a user interface element and then interacting with the underlying focused object (such as to identify an object type) may require that the search client has special permissions. For example only, in the ANDROID operating system by Google, Inc., the search client may need to be designated as a launcher app in order to access and modify views of other apps. Meanwhile, if a developer is integrating a user interface element into their own app, there is no need for special permissions.

In either the case of a standalone search client or a developer-integrated search, the query to the backend search system and the resulting responses may be similar. In some implementations, there may be differences, such as certain limitations or settings established by the developer. For example, the developer may have a blacklist of apps not to recommend. For example, the developer of an image viewing and organizing app may want to provide users with additional editing functionality, but does not want to direct users to a competitor viewing and organizing app that also has the editing features. Additional information regarding blacklists can be found in commonly-assigned U.S. patent application Ser. No. 14/683,004, “Entity-Based External Functionality for Software Developers”, filed Apr. 9, 2015, the entire disclosure of which is hereby incorporated by reference.

In addition, the developer may specify which actions should or should not be returned by the search system. For example, the developer may restrict results to only apps that allow editing or perhaps even more specifically, to apps that can perform color correction on an image. In another example, the developer may specify that apps that perform image uploading should not be returned.

The search system may return apps and/or app states organized by action. The actions that correspond to a particular object may be predefined within the search system, and may vary by object type, or may be determined dynamically based upon the actions offered by relevant apps and app states. Once presented to the user, the selection of one of these apps or app states allows the user to perform one or more of the actions associated with the selected app or app state. The search client or developer functionality may additionally provide the focused object to the selected app or app state for action.

For example, if an image has the focus in a web browser (such as if the image is centered and occupying a majority of the screen), a user interface element may be added adjacent to, on top of, or partially overlapping the image. If the user selects the user interface element, a list of actions, apps, or app states related to the focused image are displayed. The results are based on the type of the image (such as JPEG). Previously, the operating system may provide a list of applications that have specifically registered with the operating system as being able to provide some predetermined functionality. However, the list does not include applications that have not registered for the desired functionality, and could not include applications that are not yet installed.

If the user sees an action of interest, such as Red Eye Removal, the user can select an app or app state related to Red Eye Removal. The selected application is then opened and that focused file object is provided to the application. This way, a user can almost immediately begin editing, sharing, organizing, etc., multimedia objects they encounter in any app or in any website. In other implementations, the results simply identify for the user which apps have actions of interest for the focused file object. The user is then responsible for providing the focused object to any app of interest.

### User Interface

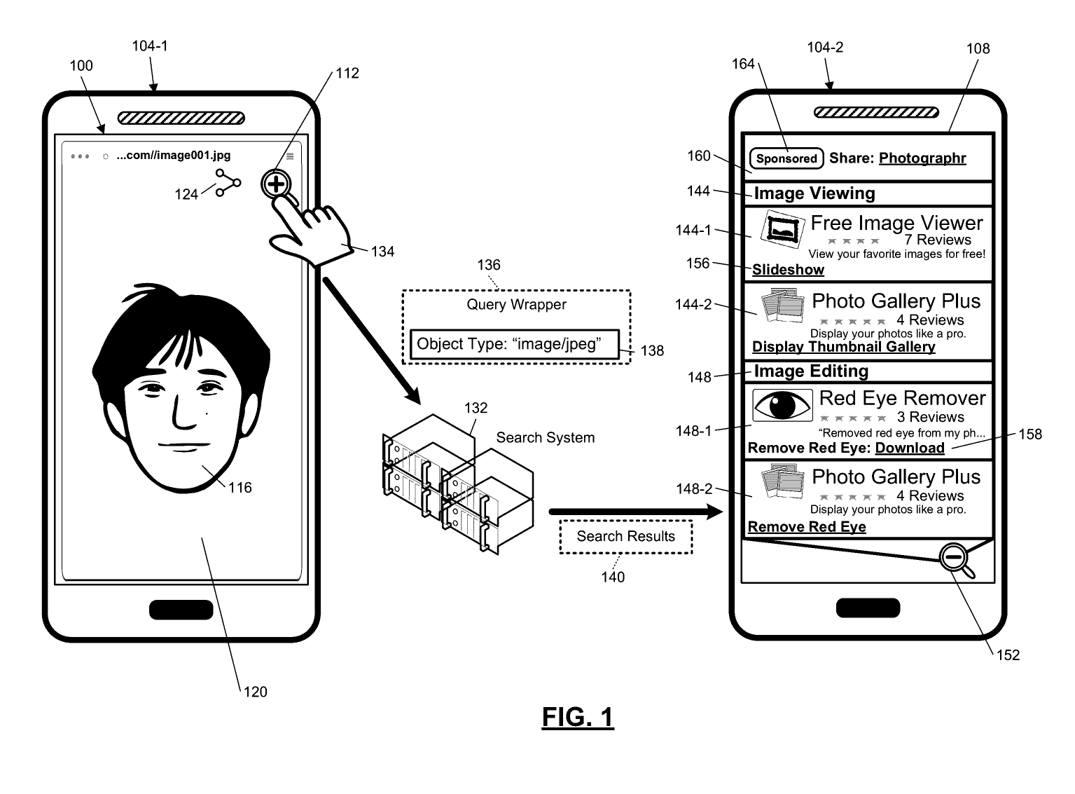

In FIG. 1, a web browser 100 is shown running on a user device 104, such as a smartphone, tablet, or laptop. The user device 104 may be any suitable user computing device, such as a gaming device, a vehicle infotainment device, a wearable device, or a smart appliance (such as a smart refrigerator or smart television). The web browser 100 is shown in a first view of the user device 104 at 104-1. A search results page 108 is shown in a second view of the user device 104 at 104-2.

A user interface element 112 is displayed and indicates that search results can be obtained for an object 116 that appears to be the focus of the user's attention in the web browser 100. In various implementations, the user interface element 112 may only be shown once the object 116 is determined to be the focus of the user, such as when a space occupied by the object 116 is greater than a percentage of space within a viewable area 120 of the web browser 100.

In various operating systems, a share user interface element 124 allows the user to select from a variety of apps in order to share a website, a media object, etc. According to the prior art, the share user interface element 124 is limited to only those applications that have been installed and have specifically registered with the operating system as being able to handle an object type.

Further, even installed and registered applications may only be able to perform a limited number of actions with respect to any given object type. For example, a web browser may allow a certain image type to be viewed, but not edited. Further, some applications may allow an action, such as editing, to be performed but within a restricted context, such as allowing an image to be edited solely within a cloud hosting environment, and not an image on the user's phone.

According to the principles of the present disclosure, the share user interface element 124 may draw, not just from a list of installed and registered applications on the user device 104, but instead from an array of apps and app states suitable for performing sharing tasks. These apps or app states may not be installed or known to the user in advance. In other implementations, the share user interface element 124 may be repurposed to offer all relevant actions for an object, including sharing.

In other implementations, the user interface element 112 may incorporate the sharing actions and the share user interface element 124 may be removed. In other implementations, the list of options could be categories or groups of actions, in a nested user interface, instead of a list of individual actions.

When a search client is installed on the user device 104, the search client overlays the user interface element 112, while the share user interface element 124 may be displayed by the web browser 100. In various implementations, the search client may obscure the share user interface element 124 with the user interface element 112 (not shown in FIG. 1).

As an alternative to the search client, the web browser 100 may incorporate code that displays the user interface element 112. As described in more detail below, this code may be obtained by a developer of the web browser 100 from an operator of a search system 132. The obtained code may also implement the search results page 108, including the functionality described below that is associated with selecting items on the search results page 108.

In FIG. 1, a cartoon representation of a user hand 134 is seen selecting the user interface element 112. Selection of the user interface element 112 causes a query to be sent to the search system 132. The search system 132 is sent a query wrapper 136, which includes at least an indication of object type 138.

The object type indication 138 in the example of FIG. 1 is shown as a multipurpose internet mail extensions (MIME) type of “image/jpeg.” Although the term MIME type will be used in the disclosure for simplicity, MIME types are now officially known as media types and are listed by the Internet Assigned Numbers Authority (IANA). MIME types may also be referred to as content types. The present disclosure is not limited to using standardized MIME types, and may use any representation of object type as long as that representation is known both to the system that determines the object type from the file as well as the search system that tracks which object types are supported by each app and app state.

The search system 132 identifies app states and/or apps that perform actions relevant to the JPEG object type in the query wrapper 136. Search results 140 are provided to the user device 104 and are shown in a search results page 108. In this example, the search results page 108 groups results together in broad action categories. A first group 144 relates to image viewing, and includes results 144-1 and 144-2. A second group 148 is related to image editing and includes results 148-1 and 148-2. While viewing and editing groups 144 and 148 are shown as examples, further groups of actions may be available, and may be accessed by scrolling within the search results page 108.

A collapse user interface element 152 causes the search results page 108 to collapse and perhaps to disappear altogether. The collapse user interface element 152 is shown with an image of a magnifying glass with a minus sign inside, but may be any icon and/or text indicating that the search results page 108 should be hidden, minimized, or dismissed.

The first image viewing result 144-1, a fictitious app called “Free Image View”, is shown with various metadata, such as number of reviews and an average rating score depicted as a number of stars. The first image viewing result 144-1 also includes text metadata, which may include text provided by the developer of the app (as shown in FIG. 1), a quotation from a review of the app, etc. The first image viewing result 144-1 includes a link 156 to a particular state of the Free Image View app—specifically, to a state where a slideshow can be displayed. Actuating the link 156 will cause the Free Image Viewer app to be opened to the state where a slideshow is displayed. In some implementations, the object 116 will be provided to the Free Image Viewer app to serve as one slide of a slideshow.

Note that, in FIG. 1, links to app states are shown. In other words, the search results page 108 allows the user to find specific pages (or, states) of already-installed apps that are relevant to the focused object as well as to identify new apps (discovery) having states of interest. In other implementations, specific app states may be omitted, and only results directed to the general apps themselves shown. Hybrid displays may be possible, with a mix of specific app state results and general app results. App state results, including those shown in FIG. 1, may be programmed to function as hybrid result displays, with user activation of the specific link leading to the specified state, while user activation of the remainder of the region devoted to an app will lead to the app being opened to its home state.

The first image editing result 148-1 is for the “Remove Red Eye” state of a “Red Eye Remover” app. The second image editing result 148-2 is for the “Remove Red Eye” state of the “Photo Gallery Plus” app. Unlike the other results, the “Red Eye Remover” app is not installed, as indicated by a “Download” link 158. Actuating the Download link 158, such as by tapping or clicking, may lead to a digital distribution platform store being opened to allow the “Red Eye Remover” app to be downloaded and installed. After installation, the “Red Eye Remover” app is opened to the state for removing red eye.

Some results, which may not otherwise have been visible on a first page of results, may be sponsored. A sponsored result is shown at 160. The sponsored result 160 is labeled with a sponsorship tag 164, and includes a link to a fictitious app called “Photographr,” which offers the ability to share images. By clicking on the Photographr link, or on the sponsorship tag 164, the user is taken to an app store to install the Photographr app. In various implementations, the Photographr app may be sponsored even if the Photographr app is already installed; sponsorship then encourages the user to engage with the Photographr app, and perhaps to use features that were previously unavailable or unknown to the user.

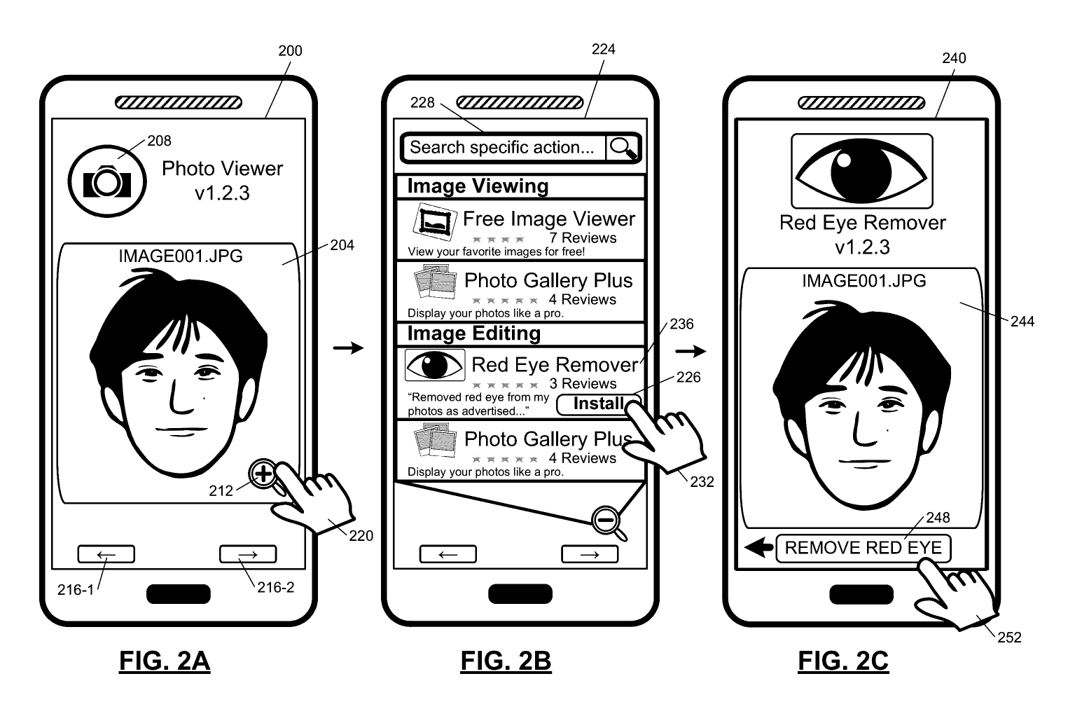

In FIG. 2A, another example app 200 (“Photo Viewer”) is shown with an image 204 displayed (“IMAGE001.JPG”). Although a logo 208 of the app 200 is also an image, the image 204 may be inferred to be the focus of the user due to the size and central location of the image 204. A user interface element 212 is shown in association with the focused object, the image 204.

In the example of FIG. 2A, the user interface element 212 is overlaid on top of a portion of the image 204. The user interface element 212 may be displayed by code contained within the Photo Viewer app 200 or by a separate search client.

The app 200 may include navigation buttons 216-1 and 216-2, which may result in a previous or next, respectively, image to be displayed in order defined by the app 200. A hand 220 is shown selecting the user interface element 212, which causes a search results page 224 to be displayed, as shown in FIG. 2B.

The search results page 224 of FIG. 2B is similar to the search results page 108 of FIG. 1, but displays results corresponding to apps and not to specific app states. Further, as one small example of variation in possible user interfaces, an “Install” button 226 may be displayed instead of the Download link 158 of FIG. 1.

A textbox 228 may be included to allow the user to search for a specific action. This search may transmit a query to a search system, or may simply apply a filter to the results already received. Applying a filter may allow more apps or app states from a given category to be displayed on the screen at once. A hand 232 is shown selecting the install button 226 of an image editing result 236 for an app titled “Red Eye Remover.” This causes the Red Eye Remover app to be downloaded, installed, and opened to the desired state, as displayed at 240 in FIG. 2C.

In FIG. 2C, the focused image of FIG. 2A has been provided to the Red Eye Remover app and is displayed at 244 so that the user can remove red eye using a button 248. In various implementations, the code that displays the search results page 224 may provide the focused image 204 to the Red Eye Remover app 240. For example, the code may make a copy of the focused image 204 and supply that copy to the Red Eye Remover app 240. A hand 252 is shown actuating the Remove Red Eye button 248.

In FIG. 2D, red eye has been removed and a hand 256 is shown actuating a “back” button 260. The back button 260 indicates the user's intent to return to the search results page 224. The back button 260 may be an operating system button or may be a button overlaid by the code that provides the search results page 224.

Any changes made in the Red Eye Remover app, such as removing red eye, may be saved in some implementations upon selecting the back button 260. For example only, upon returning to the search results page 224, a dialogue box (not shown) may ask the user whether the changes made in the Red Eye Remover app 240 should be saved. If not, the modified copy of the image is deleted or a back-up copy may be used to overwrite the modified image.

In FIG. 2E, the user types a query into the textbox 228. This query (for results related to viewing actions) may cause results to update in real time as the text “Viewing” is typed. Alternatively, a search/filter button 264 may be actuated, such as indicated in FIG. 2E by hand 268.

In FIG. 2F, as a result of the search/filter button 264 being actuated with a query of “Viewing,” an additional viewing app (“Image File Viewer”) is shown. Previously, Image File Viewer was not displayed, although the user may have been able to access Image File Viewer by scrolling within the results of the search results page 224. Additionally or alternatively, by typing in the text “Viewing,” an additional search query may be sent to the search system, which can provide additional results focused on this specific action or group of actions. For example, the Image File Viewer app may already have been present and is displayed immediately while waiting for further image viewing results from the search system.

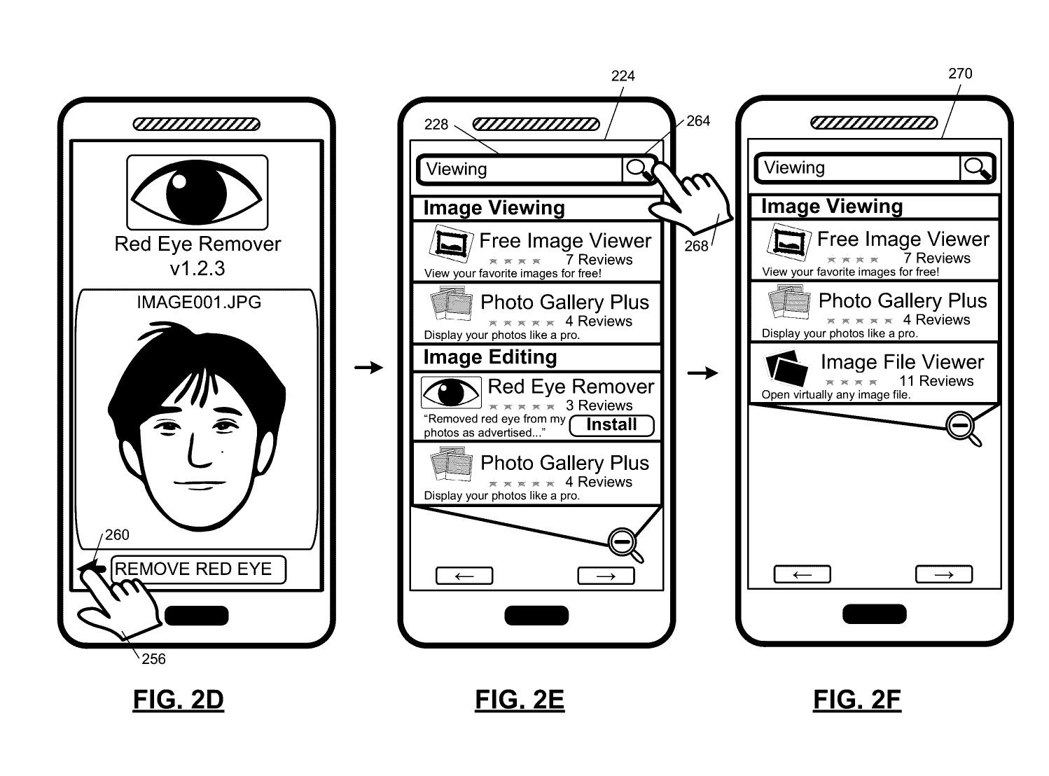

In FIG. 3A, an example of an overlay for a web browser 272 is shown. An expanding panel 276 may be expanded by pressing a user interface element 280, which is shown with an image of a magnifying glass and a plus sign. The panel 276 may be displayed any time an object within the web browser 272 appears to have the user's focus. The panel 276 may be superimposed by a search client that has sufficient privileges to modify and/or superimpose controls on another app. For example, this may be possible for a “launcher” app that includes the search client functionality.

In FIG. 3B, a Photo Viewer app 282 is shown with an expanding panel 284. Another user interface element 288 may be used to expand the panel 284. Although shown in FIGS. 3A and 3B as being located at the top or bottom of a user device screen, expanding panels may appear on the sides of the display or may be placed interior to the display, such as immediately adjacent to a border of an object. The panel 284 may be partially translucent so as not to completely block text or other information below the panel 284. The panel 284 may be hidden using various interface gestures, such as a swipe to the right or left, a swipe up or an explicit button (not shown), such as an “x”. As described above, the panel 284 may be provided by a search client or may be integrated by a developer of the Photo Viewer app.

### Action Ontology

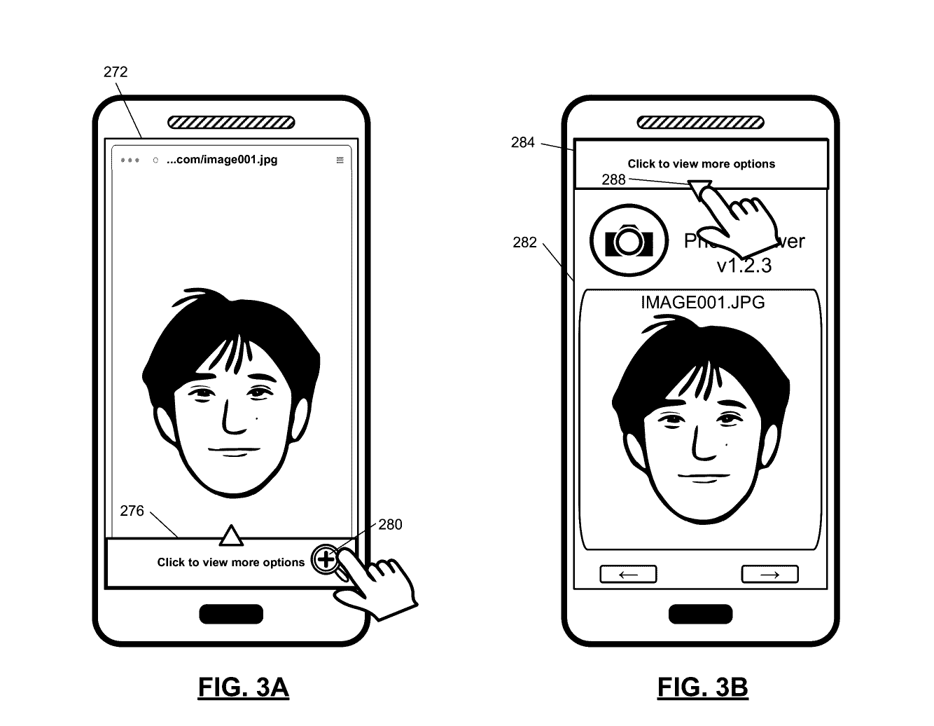

In FIG. 4, a small excerpt of an example action ontology is shown. A root node 300 of the action ontology includes a number of branch nodes, such as Image 304-1, Video 304-2, Audio 304-3, and Spreadsheet 304-4. The nodes beneath the Image 304-1 branch node are shown in this example. Leaf nodes 308-1 and 308-2 correspond to View and Share actions of an image, respectively.

An Edit branch node 308-3 is expanded to show a number of leaf nodes. For example, the leaf nodes under the Edit branch node 308-3 include Red Eye Removal 312-1, Crop/Straighten 312-2, Color Balance 312-3, Raster Editing 312-4, and Vector Annotation 312-5. In various implementations, any of the leaf nodes 312-1 through 312-5 may instead be branch nodes and include leaf nodes. For example, there is a nearly endless set of actions that the Raster Editing leaf node 312-4 could be subdivided into.

In various implementations, the View node 308-1 may be a branch node with leaf nodes (not shown). Similarly, although the share node 308-2 is shown without any leaf nodes, more specific types of sharing (such as cloud-based or email-based) may be nodes underneath the Share node 308-2. Branch nodes Video 304-2, Audio 304-3, and Spreadsheet 304-4 may include an array of branch and leaf nodes similar to those of the Image node 304-1. Likely, Edit leaf nodes for the Audio node 304-3 will be quite different than the leaf nodes underneath the Edit node 308-3 of the Image node 304-1.

Each of the groups of actions shown in FIG. 4 may be accomplished by a number of different apps. A search system may record which nodes of the action ontology apply to which apps. In other implementations, the search system records the specific actions performed by apps, and also stores mappings from an ontology node to a list of specific actions. For example, an app may be able to adjust white balance and annotate an image with a timestamp. The timestamp annotation may be mapped to the Vector Annotation leaf node 312-5, while the white balance correction action may be mapped to the Color Balance node 312-3.

In various implementations, the specific actions may simply be further nodes in the action ontology. In other words, the color balance node 312-3 may actually be a branch node, with actions such as white balance correction being leaf nodes. Each app or app state recognized by the search system may be tagged with all of the leaf nodes that are applicable from the action ontology. Then, when a higher-level node, such as the Edit node 308-3 is selected, the ontology tree can be traversed and apps or app states corresponding to all of the dependent leaf nodes can be identified as relevant to the Edit action group.

### Environment Overview

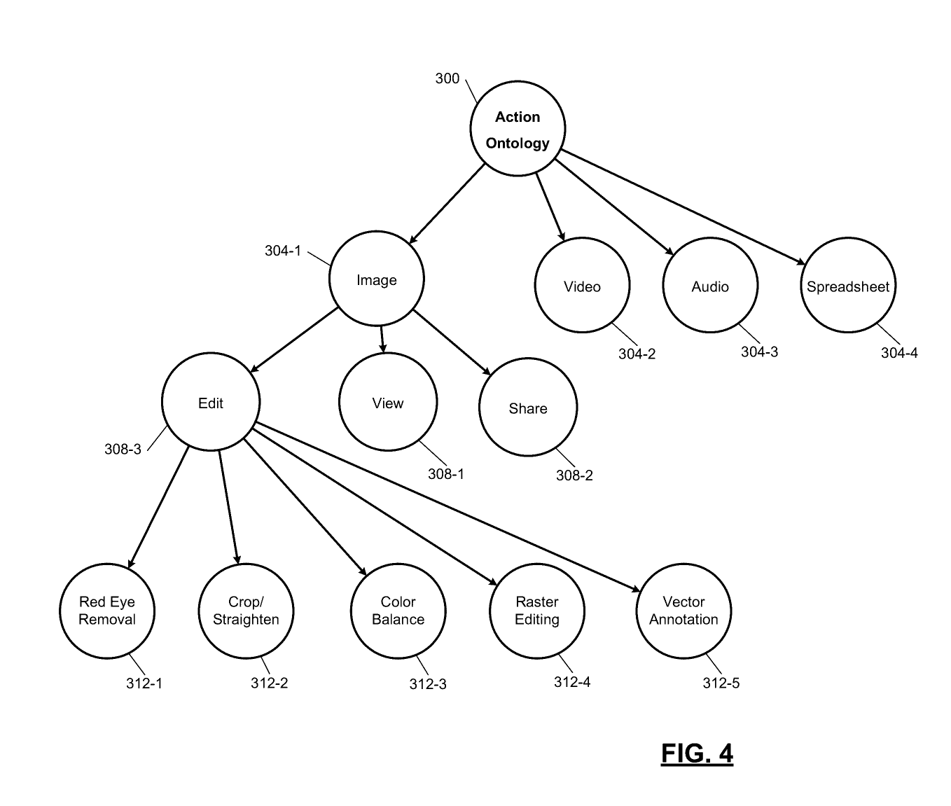

As seen in FIG. 5, the user device 104 may receive an app (named “App A”) 400 from a digital distribution platform 404. The digital distribution platform 404 may provide native applications to user devices. Example digital distribution platforms include the GOOGLE PLAY digital distribution platform by Google, Inc., the APP STORE digital distribution platform by Apple, Inc., and the WINDOWS PHONE digital distribution platform by Microsoft Corp.

While FIG. 5 shows App A 400 being provided to the user device 104 from the digital distribution platform 404, the communication may actually be carried over a network 408, as indicated by dashed lines. The network 408 may encompass local area networks, mobile phone provider networks, and a distributed communications network, such as the Internet.

App A 400 includes an object search button 410 that communicates with the search system 132 via the network 408. Specifically, a query wrapper, as discussed in more detail below, may include a text query as well as an indication of object type for a focused object, and is transmitted from App A 400 to the search system 132. The search system 132 generates results, which may include apps and states of apps, to transmit back to App A 400.

As an example, the suitable app states may include a state of another app, “App B” (not shown). If the user of the user device 104 selects a result corresponding to App B, and App B is not yet installed, the user device 104 may retrieve App B from the digital distribution platform 404.

The search system 132 may adapt the app state results based on advertising parameters from an advertiser portal 412. The advertiser portal 412 may allow an advertiser 416 to make advertising requests, such as to promote an app or app state. The advertiser portal 412 may also allow the advertiser 416 to specify keywords, bid prices, and other advertisement parameters.

### Developers

App A may be a search client, developed by an operator of the search system 132. In other implementations, the operator of the search system 132 may allow independent developers to query the search system 132. While an app developer 420 generally would prefer that a user remain within their own app, additional functionality, and therefore an improved user experience, may be provided by connecting to other apps.

Connecting to other apps may provide a better user experience than attempting to replicate the functionality within the developer's own app. For example, if the app developer 420 is skilled at displaying images and possesses valuable data and processing algorithms related to image rendering, the app developer 420 may not have expertise related to editing images. The app developer 420 can therefore rely on other apps whose focus is directed to editing images.

In order to access the functionality of another app, the app developer 420 could hardcode a reference to that app when writing their code. However, hardcoding access to other specific apps is an exercise in guesswork because the constant evolution of the app ecosystem means that the most popular, the most widely installed, and the most useful apps in any category may not be clear and may change with time.

For certain functions, a request may be passed to the operating system. For example, to map a location or to generate directions to a destination, a request can be passed to the operating system. The operating system may present the user with a list of installed apps to service that request. The operating system may allow the user to choose one of the apps as a default and, once a default is selected, the average user may never revisit that choice. Certain operating systems may not present a choice for certain requests, instead passing the request to a default app or service unless a specific configuration change is made by the user.

For all these reasons, the ability of the app developer 420 to connect to other apps that would provide valuable functionality to the app developer's users is limited and difficult to implement. There is also no systematic way for developers to enter business relationships with each other. For example, an ad hoc arrangement may be possible where the developer of a second app compensates the app developer 420 each time that the second app is installed as a result of an advertisement or suggestion within an app of the app developer 420.

The present disclosure presents a system where the app developer 420 can quickly and easily add a wide variety of external functionality to an app, where that functionality is tailored to the type of object that has the focus in the app. Instead of hardcoding for specific apps based on a guess of what action a user may want to perform, the present disclosure allows the developer to pass a query to a search system, which can provide apps or app states that provide relevant (and maybe even unexpected) functionality. These app results may include apps already installed and may also include apps not yet installed. For apps that are not yet installed, a mechanism may be provided for easy installation of the app.

A monetization system may include the advertiser portal 412, which allows a third-party developer to promote their app. The app developer 420 can be compensated for activity driven to apps of the third-party developer. For example, compensation may be based on one or more of impressions (a user seeing the sponsored app), clicks (a user clicking, touching, or otherwise selecting the sponsored app being presented by the app developer 420), cost per action or engagement (advertiser determines the action or engagement they are willing to pay for), and installs (when the sponsored app had not previously been installed and, as a result of the first app developer, the sponsored app being installed by a user). A portion of the revenue received from an advertising developer may be retained by the monetization system and the remainder is distributed to the app developer 420.

A developer may decide to promote their app even if they do not take advantage of the object-type-based search provided by the present disclosure. The advertiser may commit to paying a specified amount when their app is one of the results presented to a user. The advertiser may pay to promote their app, such as by visually enhancing their app within the results or moving the result further up in the results list. In addition, as described in more detail below, the advertiser may specify keywords or competitor establishments or products that will lead to the advertiser's states being displayed.

To allow the app developer 420 to harness the functionality of the rest of the app ecosystem with a minimal amount of extra coding, a developer portal 424 is offered to developers. The developer portal 424 offers pre-written code that the app developer 420 can incorporate into their app (such as App A) with little to no custom coding. The pre-written code may be offered as part of a software development kit (SDK), which may be implemented as a plugin for an integrated development environment, or as one or more libraries or packages.

Included with the code (referred to below for simplicity as an SDK library) or provided separately are user interface elements, such as logos, fonts, and graphics. The app developer 420 may add the object search button 410 or other user interface element to one of the states (or, screens) of App A, where the action performed by the button (querying the search system and displaying results) is simply provided by a call to the SDK library. The software development kit may even automate creation and placement of a button or other user interface element and may automatically associate the button with corresponding code, such as a routine or function contained within the SDK library.

The developer portal 424 may allow the app developer 420 to make choices relating to monetization, such as whether and how sponsored apps should be presented to a user, and how to be compensated for the display, access, or installation of sponsored apps. The app developer 420 may also be able to select apps or classes of apps not to present to the user. For example, the app developer 420 may not want to present a third-party app that is a competitor of the app developer 420 or that duplicates some of the functionality of App A. The app developer 420 may also specify actions that should be or should not be presented to the user, such as a TV network video player that might not permit certain videos to be shared or edited.

The settings chosen by the app developer 420 may be stored local to the app developer 420 and integrated into the app itself or may be stored by the developer portal 424 and shared with the search system 132. As mentioned above, when an end user of App A clicks on the object search button 410, the SDK library sends a query to the search system 132, which returns results, including names, icons, and other metadata related to apps or app states, and may include a ranking of the relevance of the results.

The results can be displayed to the user by code included within the libraries or packages provided by the developer portal 424. The results may be presented by themselves in a full screen or as only part of the screen real estate of App A. In some implementations, the developer is allowed to develop their own custom presentation layout for how the returned apps will be displayed. In other implementations, the display format may be fixed by the provider of the development portal. Although the provider of the development portal and the provider of the search system will be treated as a single entity below for ease of explanation, the developer portal 424 and the search system 132 may be operated by independent organizations.

For simplicity of explanation, the below discussion will refer to a search client. The search client encompasses a standalone search client that overlays object search buttons on other apps. The search client also encompasses an app (such as App A) developed with object search code built in, such as from an SDK provided by the developer portal 424.

### Query Wrappers

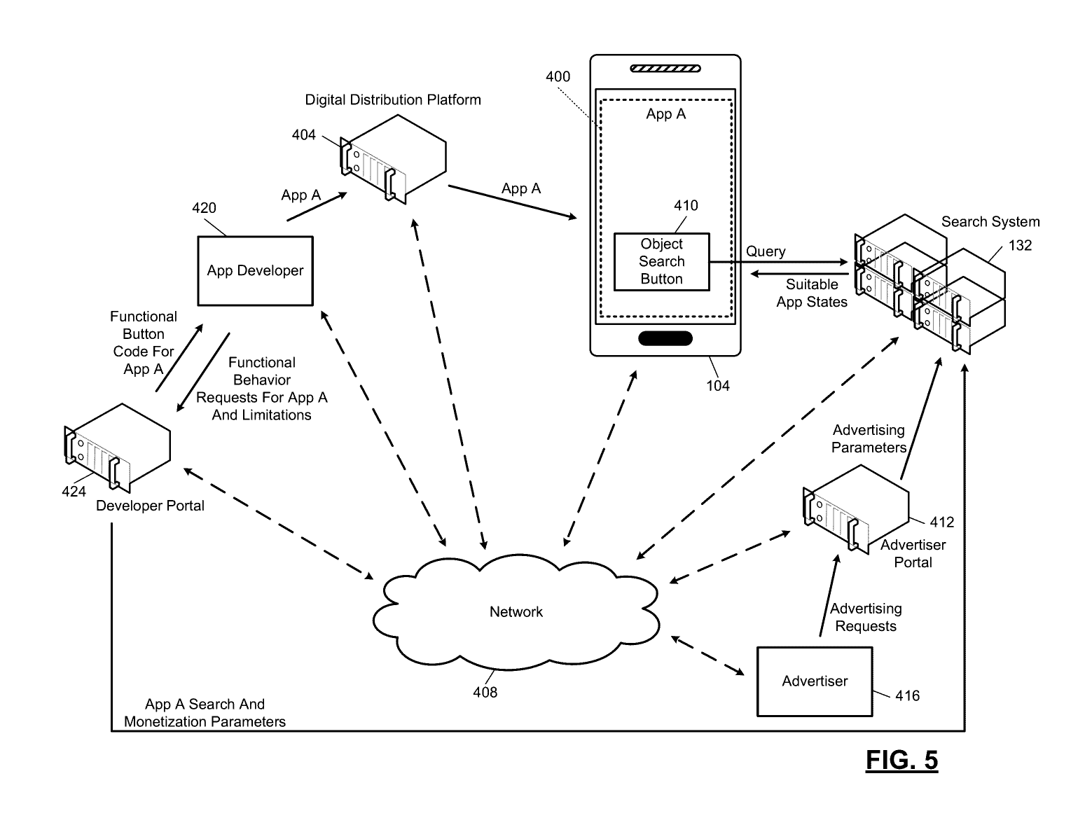

In FIG. 6A, an example query wrapper 504 can be, in various implementations, encrypted with a public key of the search system 132. This public key may be embedded in the search client and its use prevents any eavesdropper from inspecting or modifying the query wrapper 504. Only the search system 132 has the corresponding private key.

The query wrapper 504 includes an object type 504-1 indicating the object type of the focused object, and may be a string storing the name of a MIME type. Alternatively, the object type 504-1 may be a shortened representation pre-arranged between the search client and the search system 132. In other implementations, the object type 504-1 may be a text string of the extension of the file of interest.

A representation of installed apps 504-2 may be included. For example, an exhaustive listing of all installed apps (which may be specified by title or a unique identifier and may include version number) may be included. In other implementations, a bit field may be specified for a set of the most popular apps. In one example, 100 binary digits correspond to whether each of the 100 most popular apps are installed. The 100 most popular apps must be known to both the search client and the search system 132. If the most popular apps change over time, the search system 132 will need to alert the search client so that the bit field is interpreted correctly. Although 100 is used as an example, a power of two (such as 128) may be used for greater storage efficiency—that is, there may not be any additional storage space required to represent 128 apps compared to 100.

Another mechanism for indicating installed apps using a limited amount of data is a Bloom Filter. The Bloom Filter specifies whether an app from a pre-defined set of apps is potentially installed on the device or whether the app is definitely not installed. To achieve reduced storage space, the output of a Bloom Filter does not definitively state whether a certain app is present; only whether an app is definitively not present.

An accounts structure 504-3 indicates which accounts are present on the user device and any relevant details about those accounts, such as whether the account is active. This may impact how relevant an app state is, and therefore its place or even presence in the search results rankings. For example, if the user has an active account with the ADOBE CREATIVE CLOUD content creation service, app states corresponding to the CREATIVE SUITE may be prioritized, and vice versa. A device information data structure 504-4 may encode the operating system identity and version number, geolocation data of the user device, screen resolution, orientation (portrait or landscape), and sensor capability (such as precision of accelerometer or presence of heart rate sensor).

In FIG. 6B, a query wrapper 508 may be similar to the query wrapper 504, except that instead of an object type, the query wrapper 508 includes a copy 508-1 of all or a portion of the specified file, such as a copy of the file header. The file or file header may be sent to allow the search system 132 to make a determination about the object type, and the search client may omit any independent object type determination logic. In other implementations, the file header may be sent only if the search client is unable to determine the object type. The object type may be specified as microdata using a vocabulary from schema.org.

In FIG. 6C, a query wrapper 512 is similar to the query wrappers 504 and 508, but developer data 512-1 is included. The developer data may include an ID of the developer to allow the search system 132 to look up parameters specific to the developer. For example, the developer may have specified (using the developer portal) a blacklist of apps not to return as results. The developer data 512-1 may include its own blacklist, which may supplement a blacklist maintained by the search system 132 or may be self-complete. In addition, a query object 512-5 may be included, which specifies actions or sets of actions the developer wants the search system to return. The query object 512-5 may also specify a user query or action filter.

### Results

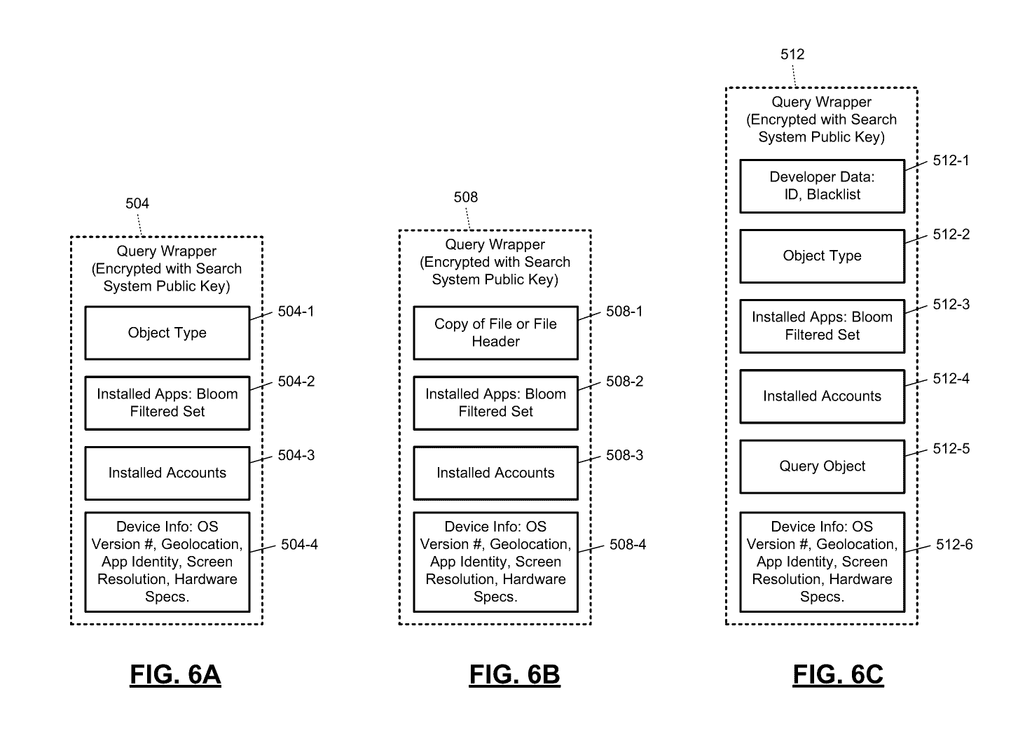

In FIG. 7A, a search results structure 604 includes an app list 604-1. For example, the app list 604-1 may include an array of strings, each string storing an app name. The array may generally be ordered from most relevant to least relevant, though the order may be adjusted based on sponsorship. The number of apps provided in the app list 604-1 may be chosen according to a resolution of the device sending the query wrapper. For example, a device with a larger screen and/or higher resolution may receive a larger number of apps.

An app state list 604-2 includes an array of tuples, where a first value of each tuple corresponds to an app state (which may be a title, such as “remove red eye”), the second value of each pair corresponds to the associated app (such as the “Red Eye Remover” app), and the third corresponds to a result score from the search system indicating relevancy of the result. In other implementations, the tuples may omit the result score.

An images field 604-3 may include images, such as icons, for each of the apps in the app list 604-1. In other implementations, the images field 604-3 may include images, such as screenshots, for each of the app states in the app state list 604-2.

An app access links field 604-4 specifies access mechanisms for a default state of each of the apps in the app list 604-1. For example, the access links may include commands to open the app if installed and/or links to a digital distribution platform to download an app that is not installed. Another access mechanism may be a URL (uniform resource locator) to access a web-based app through a browser. When the search results structure 604 is returned, code within the app may determine whether open versus download is the appropriate action based on the specific installation status of each app.

An app state access links field 604-5 specifies access mechanisms for each of the app states in the app state list 604-2. As described below, an access mechanism may include a link to a web page or an application programming interface call to open an app directly to a state. The access mechanism may instead include a script to open an app and navigate to the specific state. An access mechanism may also include instructions (such as in a script) to download and install an app from a digital distribution platform before opening the app.

Additional metadata 604-6 may include a rating for each app (such as a number of stars), a text description for each app, review text and metrics (such as number of reviews), and a designation of sponsorship. The sponsorship designation may be a simple binary flag or may include an indication of sponsorship level. For example, a sponsor may be willing to pay a greater amount for a new install than for usage of an existing app. This level of interest by the sponsor may allow the search app to promote the sponsored app more prominently in hopes of recognizing that revenue.

The additional metadata 604-6 may include download velocity or other indicators of trending popularity of an app. A new and valuable app may not yet have a large installed base, but may show rapid growth in number of downloads. Therefore, trending popularity may be used as a signal to rank the display of apps, with trending apps moved higher up in a results list. Further, a visual indication of trending, such as text (“trending” or a word correlated with trending, such as “popular”) or an icon, may be shown in close proximity to an app for which a trending metric of the app is above a threshold. The threshold may be an absolute threshold for all apps, or may be relative/normalized to the market segment in which the app exists or to the other apps in the results list.

In FIG. 7B, a search results structure 606 is similar to the search results structure 604 but is specific to apps only, excluding app states.

In FIG. 7C, a search results structure 608 includes an HTML (hypertext markup language) image map 608-1. The HTML image map 608-1 may be a single image, such as a JPEG (joint photographic experts group) or PNG (portable network graphics) image, divided into separate areas. Each area corresponds to an app or app state and shows text and/or icons corresponding to that app or app state. When the HTML image map is actuated, the corresponding section of the image map activates a corresponding access mechanism for the app or state displayed in that region of the HTML image map 608-1.

The HTML image map 608-1 may be sized by the search system 132 according to the size of the requesting device. In other implementations, the search system 132 may provide HTML image maps of varying sizes and an appropriate one may be selected at the user device according to the resolution of the device's screen and the amount of real estate to be dedicated to the results display. The search system 132 may create an HTML image map that will work with a certain range of display sizes and resolutions, and if the specified region for display is within that certain range, the HTML image map may be proportionally scaled by the device.

### Search System

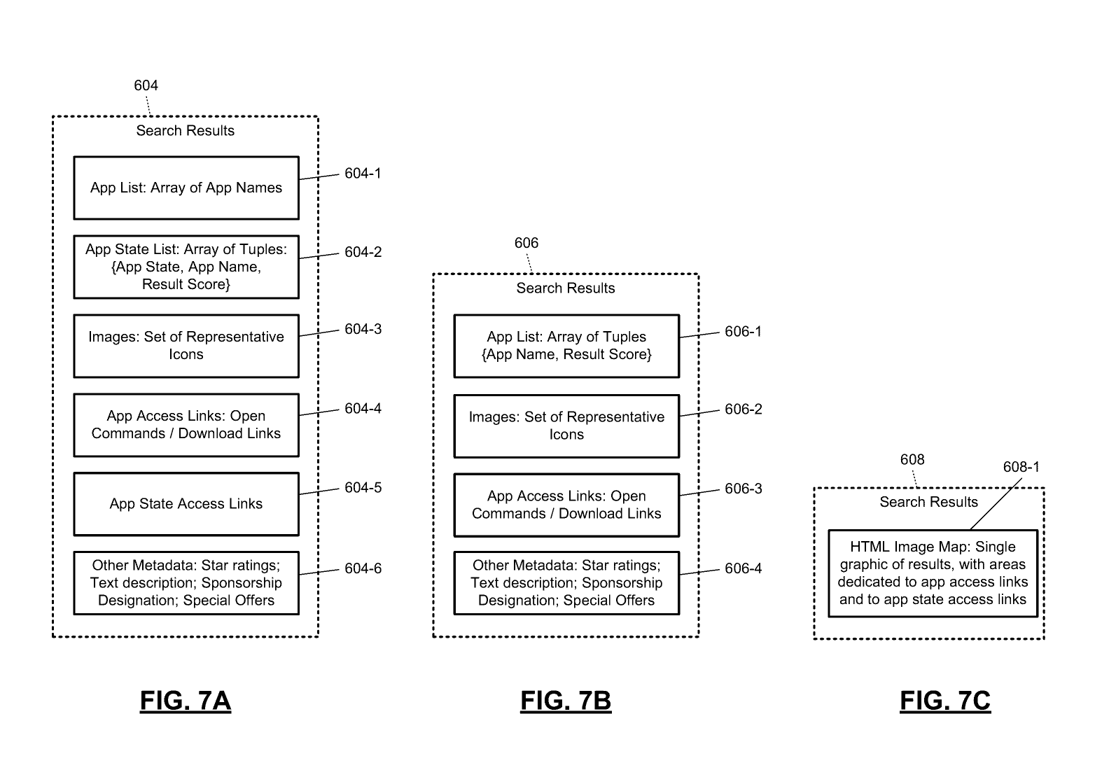

FIG. 8 illustrates an example environment of the search system 132. The search system 132 is a collection of computing devices that receives search queries from user devices via the network 408. In some implementations, user devices communicate with the search system 132 via a partner computing system (not illustrated). The partner computing system may be a computing system of a third party that leverages the search functionality of the search system 132. The partner computing system may be owned by a company or organization other than the operator of the search system 132.

Examples of such third parties include Internet service providers, aggregated search portals, and mobile phone providers. The user devices may send search queries to the search system 132 and receive search results from the search system 132, all via the partner computing system. The partner computing system may provide a customized user interface to the user devices and/or may modify the search experience provided on the user devices.

The example implementation of the search system 132 shown in FIG. 8 includes a search module 700, which references app state data stored in a search data store 704 and object type data stored in an object type data store 708. The data in the search data store 704 and the object type data store 708 may be obtained from data sources 712. The search data store 704 and the object type data store 708 may be maintained and updated by the search module 700 and/or a maintenance component (not shown) of the search system 132.

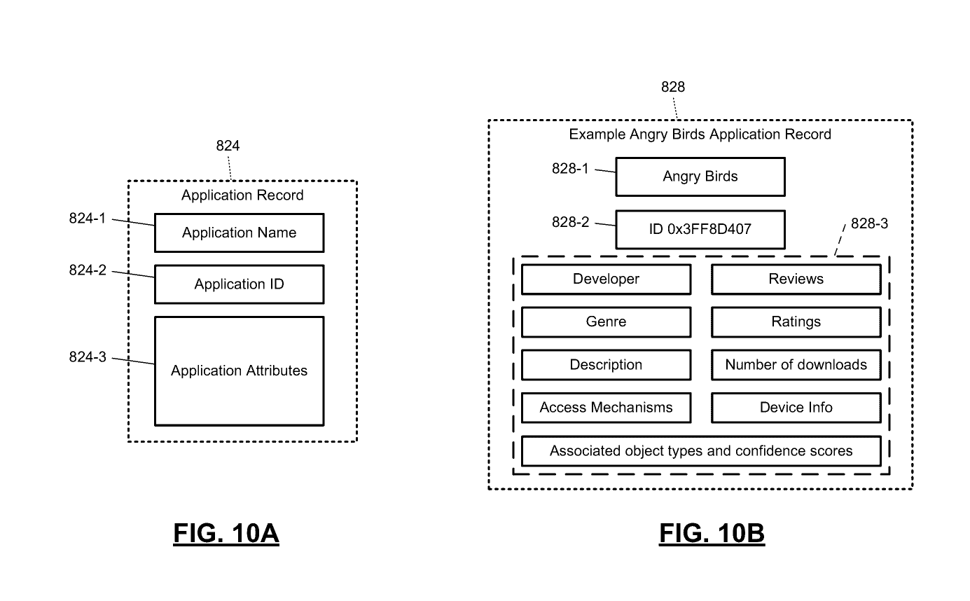

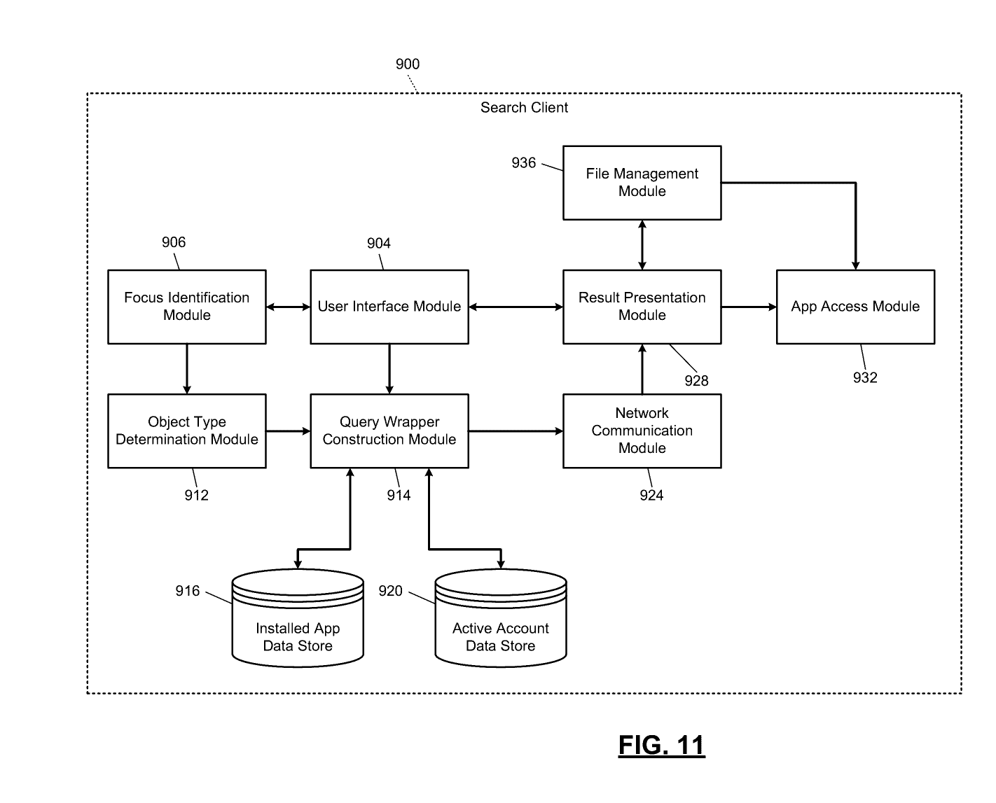

The search data store 704 and the object type data store 708 may be updated with databases, indices, tables, files, and other data structures, which may be populated from the data sources 712. The search data store 704 may store app state records, which may be in the format shown in FIG. 10A.

Parsers and other ETL (extract, transform, and load) processes may adapt data from the data sources 712 for storage in the search data store 704. In some implementations, data may be manually entered and/or manually transformed into a format usable by the search data store 704. The data sources 712 may include data from application developers 712-1, such as application developers' websites and data feeds provided by developers.

The data sources 712 may include digital distribution platforms 712-2, accessed via the web or via an app. The data sources 712 may also include other websites, such as blogs 712-3, application review websites 712-4, and social networking sites 712-5, such as the FACEBOOK application and website by Facebook, Inc. and the TWITTER application and website by Twitter, Inc.

The data sources 712 may also include online databases 712-6 of data related to movies, television programs, music, restaurants, etc. Each of the data sources 712 may have independent ontologies and may be updated at different rates. Therefore, the search data store 704 may be updated from each of the data sources 712 at different rates. In addition, credibility and accuracy of data may differ across the data sources 712. Measures of reliability, timeliness, and accuracy may be stored in the search data store 704 and may be used to weight search results obtained from those data sources 712.

As described above, the search system 132 generates search results based on a search query and an indication of an object type received from a user device, and based on the data included in the search data store 704. Specifically, the search module 700 identifies one or more app state records included in the search data store 704 based on the search query and the object type indication. The search module 700 uses one or more app state IDs that identify the identified app state records to select one or more access mechanisms from the identified records and transmits the selected access mechanisms to the user device as search results. In some examples, the search module 700 receives the indication of the object type from the user device and identifies the app state records based on the indication.

The search data store 704 includes information for each app and/or for each app state regarding the supported object types for that app or app state. For a given app state, the search data store 704 may store a list of object types that are definitely supported, a list of types that are definitely not supported, a list of object types that may be supported, etc. In one example, the search data store 704 may include an array of object type tuples. Each tuple may include a MIME type and a confidence value. The confidence value may indicate how confident the search system 132 is regarding the ability of the app state to process that object type.

In one implementation, a confidence value of 1 indicates absolute confidence that the app state can handle that object type. A confidence value of −1 indicates absolute confidence that the app state cannot handle that object type. A confidence value of 0 may indicate that there is no data regarding whether the app state can handle that object type.

Various compression schemes may be used to reduce the amount of storage required to store this array of tuples for each app state. For example, many image programs may be able to handle a certain set of image types. This set of image types may be identified as a group type. Then an app state only needs to add a tuple specifying that group and a confidence value in order to refer to every object type within the group. Further, for a given app state, object types for which there is little to no information (which may correspond to a confidence value of approximately zero) may not be stored at all.

The object types able to be handled by app states may be determined, in various implementations, by consulting a manifest file for the app. The manifest file may specify which object types are handled by the app. In the absence of other information, it may be assumed that each action performed by the app can therefore handle those object types. In other implementations, the manifest file may specify supported object types on a per-state basis.

An example of a data tag in a manifest file is “android:mimetype=image/jpeg”, which indicates that the app supports jpeg images. When a manifest file does list supported object types, an inference may be made that any non-listed object types are not supported. This may be reflected in the data for the app state by specifying that “all other types” have a confidence value of −1.

Another example data tag from a manifest file is “android:mimetype=image/*”, which conveys that the application accepts all image types. The search data store 704 may define a group that includes all image types of interest to the search system 132. The corresponding app state of this app therefore has a tuple corresponding to the group of all images and a confidence value of 1 (or less than 1). The confidence value may be less than 1 because it is quite likely that an app purporting to accept all image types will be unable to handle every rare image type.

Feedback, such as from users, operators of the search system 132, and application feedback (such as crash reports from apps unable to process certain object types), may be used to update the app state records in the search data store 704. For example, an app that purports to accept all image types may be determined to be unable to handle a certain image type (such as PGF, or progressive graphics file). As a result, another tuple will be added to the app or app state to indicate a negative confidence value for that object type. For this reason, when parsing object type tuples for an app state, the search system 132 may look at more specific tuples, such as those tuples directed to a single object type, as being controlling over more general tuples, such as those that apply to a group of image types.

A developer data store 716 stores preferences from an app developer. For example, the app developer may provide those preferences to the search system 132 via the developer portal 424. Additionally or alternatively, developer settings may arrive in the query wrapper. These settings may be saved in the developer data store 716 for future use or may apply only to the present query.

For example, the developer data store 716 may store blacklist information, used to exclude apps or app states that match the blacklist criteria. The developer data store 716 may also store search query information. For example, the developer data store 716 may record that whenever a query comes from a particular application, the desired action is a predefined first action.

The developer data store 716 may also store settings for a developer generally that apply to all apps from that developer. For example, these settings may include which actions should be shown. These setting may also include a blacklist of actions that are either not of use to the developer's users or may duplicate actions already provided by the developer's apps.

Further, the developer may specify different searches for different states of an app. Therefore, the developer data store 716 may store state specific search queries. These state specific queries may be unique to different states of the developer's app or to different templates used by the developer. For example, one template may be used with different input data to produce a variety of different states. However, the developer may desire to have the same action search performed in any of those states corresponding to that template.

### App State Records

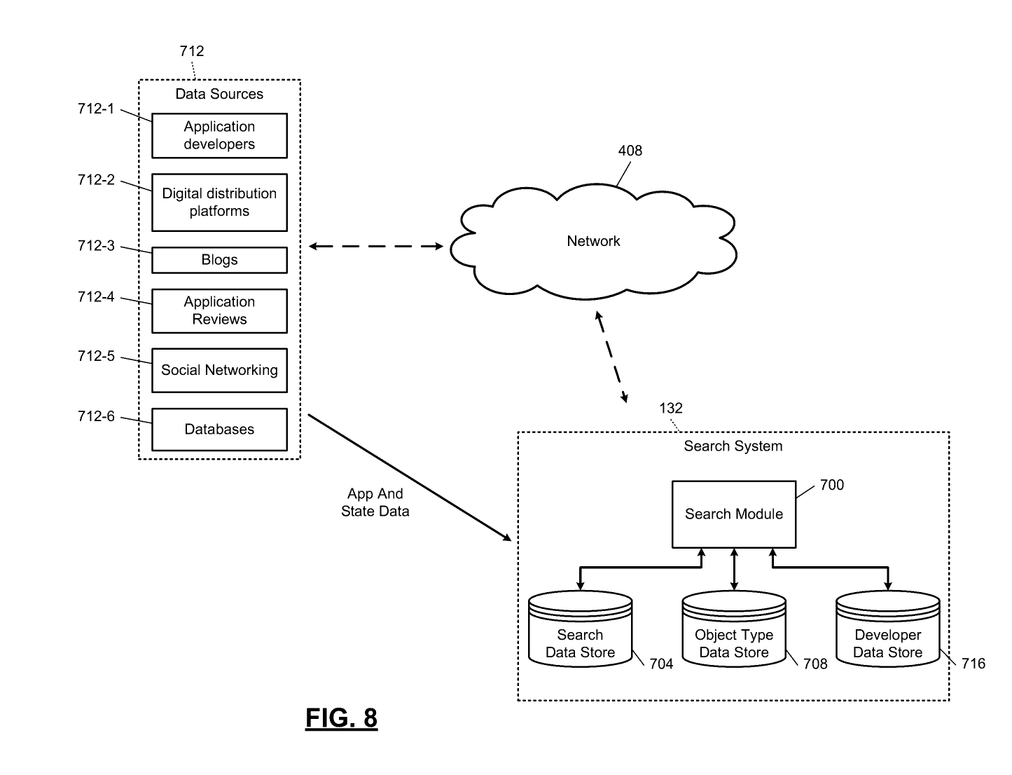

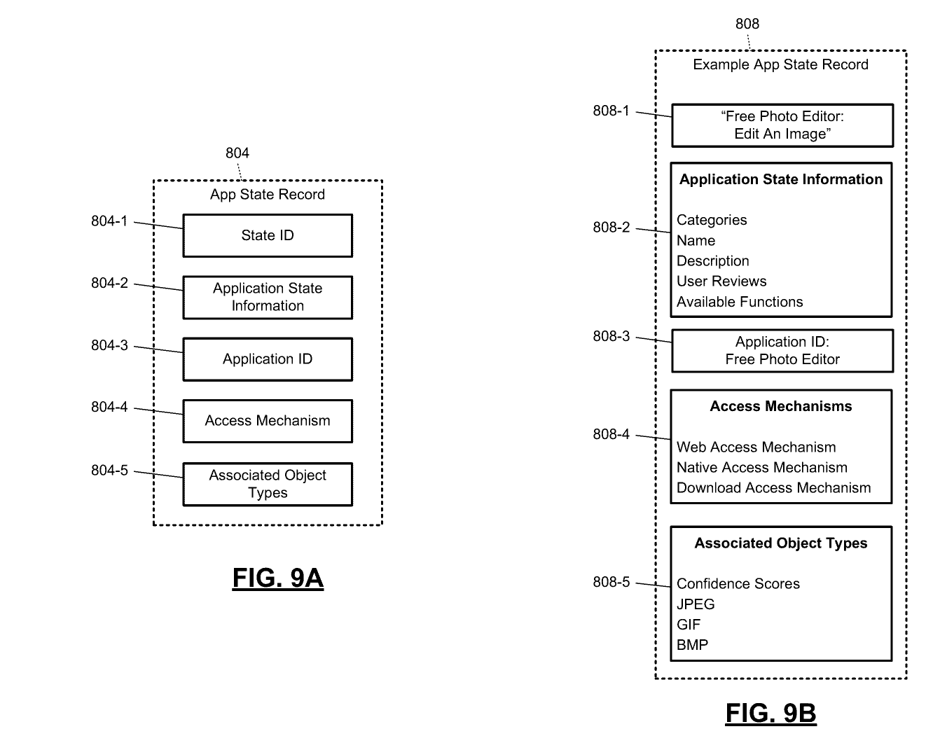

In FIG. 9A, an example format of an app state record 804 includes a state identifier (ID) 804-1, app state information 804-2, an application identifier (ID) 804-3, one or more access mechanisms 804-4 used to access the application state, and associated object types 804-5 handled by the application state.

The state ID 804-1 may be used to uniquely identify the app state record 804 among the other app state records included in the search data store 704. In some examples, the state ID 804-1 describes a function and/or an application state in human-readable form. For example, the state ID 804-1 may include the name of the application referenced in the access mechanisms 804-4.

In a specific example, a state ID 804-1 for an Internet music player application may include the name of the Internet music player application along with the song name that will be played when the Internet music player application is set into the state defined by the access mechanism 804-4 included in the app state record 804. In some examples, the state ID 804-1 includes a string formatted similarly to a uniform resource locator (URL), which may include an identifier for the application and an identifier of the state within the application. In other implementations, a URL used as the state ID 804-1 may include an identifier for the application, an identifier of a function to be provided by the application, and an identifier of an entity that is the target of the function.

The app state information 804-2 may include data that describes an application state into which an application is set according to the access mechanisms 804-4 in the app state record 804. The types of data included in the app state information 804-2 may depend on the type of information associated with the application state and the functionality specified by the access mechanisms 804-4. The app state information 804-2 may include a variety of different types of data, such as structured, semi-structured, and unstructured data. The app state information 804-2 may be automatically and/or manually generated and updated based on documents retrieved from the data sources 712.

In some examples, the app state information 804-2 includes data presented to a user by an application when in the application state corresponding to the app state record 804. For example, if the app state record 804 is associated with a music player application, the app state information 804-2 may include data that describes a song (e.g., name and artist) that is displayed and/or played when the music player application is set to the specified application state.

When the app state record 804 corresponds to a default state of an application, the app state information 804-2 may include information generally relevant to the application and not to any particular application state. For example, the app state information 804-2 may include the name of the developer of the application, the publisher of the application, a category (e.g., genre) of the application, a text description of the application (which may be specified by the application's developer), and the price of the application. The app state information 804-2 may also include security or privacy data about the application, battery usage of the application, and bandwidth usage of the application. The app state information 804-2 may also include application statistics, such as number of downloads, download rate (for example, average downloads per month), download velocity (for example, number of downloads within the past month as a percentage of all-time downloads of the app), number of ratings, and number of reviews.

The application ID 804-3 uniquely identifies an application associated with the app state record 804. The access mechanisms 804-4 specify one or more ways that the state specified by the app state record 804 can be accessed. For any given user device, only some of the access mechanisms 804-4 may be relevant.

For illustration, in FIG. 9B an example app state record 808 includes a state ID 808-1 in the form of human-readable text: “Free Photo Editor: Edit An Image”. The example app state record includes application state information 808-2, including app category, state name, text description, user reviews (numerical and/or text), and available functions. For example, the available functions for this state may include cropping the image, rotating the image, and removing red eye.

An application ID 808-3 uniquely identifies the Free Photo Editor app. The application ID 808-3 may refer to a canonical Free Photo Editor software product that encompasses all of the editions of the Free Photo Editor application, including all the native versions of the Free Photo Editor application across platforms (for example, the IOS operating system and the ANDROID operating system) and any web editions of the Free Photo Editor application.

There are three access mechanisms 808-4 shown: a web access mechanism, a native app access mechanism, and a native download access mechanism. The web access mechanism may take the form of a URL (uniform resource locator) that corresponds to a web page for “Edit An Image” on the Free Photo Editor website.

The native access mechanism may include an application resource identifier for the native edition of the Free Photo Editor app on a particular operating system and one or more operations that navigate to the state in the Free Photo Editor app for the Edit An Image state. In various implementations, and for various app states, an access mechanism may be able to directly access the state (such as by using an ANDROID operating system intent). If the Free Photo Editor: Edit An Image app state is available on multiple operating system platforms, there would generally be multiple native access mechanisms.

The download access mechanism may include instructions to open a portal to a digital distribution platform to download and install the app, followed by opening the app and navigating to the correct state, where the opening and the navigating may be the same as the native access mechanism. In other words, the actions taken by the download access mechanism may be a superset of those of the native access mechanism.

### App Records

In FIG. 10A, an example format of an application record 824 includes an application name 824-1, an application identifier (ID) 824-2, and application attributes 824-3. The application record 824 generally represents data that can be stored in the search data store 704 for a specific application. The search data store 704 may include thousands or millions of records having the structure specified by the application record 824. The application ID 824-2 uniquely identifies an application in the search data store 704. The application ID 824-2 may be assigned by the search system 132 and may therefore be independent of any ID assigned by, for example, a digital distribution platform.

A single value for the application ID 824-2 may cover multiple application editions. The term “edition” applies to multiple versions of a single app and may also apply to versions of that app released for alternative operating systems. For example only, Angry Birds (as shown in FIG. 10B) may be available on Android and iOS mobile device platforms and, for each platform, may have a series of versions bug fixes are released and as the application is updated to take advantage of, and to adapt to, newer versions of operating system.

In FIG. 10B, an example application record 828 for an ANGRY BIRDS app includes a name 828-1 of “Angry Birds” and a unique ID 828-2 expressed in hexadecimal as Ox3FF8D407. Attributes 828-3 for Angry Birds may include a name of the developer of Angry Birds, text reviews of Angry Birds, a genre indicator for Angry Birds (such as “Games,” or sub-genre “Physics-Based Games”), ratings (such as star ratings) for Angry Birds, a textual description (which may be provided by the developer), a number of downloads (which may be restricted to the most recent edition or could be for all editions), access mechanisms (how to open Angry Birds when already installed or how to install Angry Birds when not yet installed), and device info (for example, minimum requirements of operating system, hardware, and resolution for best operation). The attributes 828-3 may also include associated object types and confidence scores regarding how confident the search system is that the Angry Birds app can act on the specified object types.

The term “software application” can refer to a software product that causes a computing device to perform a function. In some examples, a software application may also be referred to as an “application,” an “app,” or a “program.” Software applications can perform a variety of different functions for a user. For example, a restaurant reservation application can make reservations for restaurants, and an Internet media player application can stream media (such as a song or movie) from the Internet.

In some examples, a single software application can provide more than one function. For example, a restaurant reservation application may also allow a user to read user reviews for a restaurant in addition to making reservations. As another example, an Internet media player application may also allow a user to perform searches for digital media, purchase digital media, generate media playlists, and share media playlists.

The functions of an application can be accessed using native application editions of the software application and/or web application editions of the software application. A native application edition (or, “native application”) is, at least in part, installed on a user device. In some scenarios, a native application is installed on a user device, but accesses an external resource (e.g., an application server) to obtain data from the external resource. For example, social media applications, weather applications, news applications, and search applications may respectively be accessed by one or more native applications that execute on various user devices. In such examples, a native application can provide data to and/or receive data from the external resource while accessing one or more functions of the software application.

In other scenarios, a native application is installed on the user device and does not access any external resources. For example, some gaming applications, calendar applications, media player applications, and document viewing applications may not require a connection to a network to perform a particular function. In these examples, the functionality of the software product is encoded in the native application itself.

Web application editions (also referred to as “web applications”) of a software application may be partially implemented by a user device (such as by a web browser executing on the user device) and partially implemented by a remote computing device (such as a web server or application server). For example, a web application may be an application that is implemented, at least in part, by a web server and accessed by a web browser native to the user device. Example web applications include web-based email, online auctions websites, social-networking websites, travel booking websites, and online retail websites. A web application accesses functions of a software product via a network. Example implementations of web applications include web pages and HTML5 application editions.

When rendering a set of app search results, a user device displays a set of user-selectable links that can be selected by a user of the user device. A user-selectable link may include one or more underlying access mechanisms. A user-selectable link, when selected by a user, causes the user device to access a software application using an edition of the software application identified by the access mechanism.

Examples of access mechanisms include application access mechanisms, web access mechanisms, application download addresses, and scripts. An application access mechanism may be a string that includes a reference to a native application and indicates one or more operations for the user device to perform. If a user selects a user selectable link including an application access mechanism, the user device may launch the native application referenced in the application access mechanism.

In some implementations, any combination of the operating system of the user device, a search application executed by the user device, a native application executed by the user device, and/or a web browser executed by the user device can launch the native application referenced in the application access mechanism. An application resource identifier is an example application access mechanism.

A web access mechanism may be a string that includes a reference to a web application edition of a software product, and indicates one or more operations for a web browser to execute. A web access mechanism may be a resource identifier that includes a reference to a web resource (e.g., a page of a web application/website). For example, a web access mechanism may refer to a uniform resource locator (URL) used with hypertext transfer protocol (HTTP). If a user selects a user-selectable link including a web access mechanism, the user device may launch a web browser application and may pass the resource identifier to the web browser.

An application download access mechanism may indicate a location (such as a digital distribution platform) where a native application can be downloaded in the scenario where a native application edition of the application is not installed on the user device. If a user selects a user-selectable link including an application download access mechanism, the user device may access a digital distribution platform from which the referenced native application edition may be downloaded. The user may opt to download the native application edition. Upon installation, the user device may automatically launch the native application edition.

A script access mechanism is a set of instructions that, when executed by the user device, cause the user device to access a resource indicated by the script. For example, the script may instruct an operating system of the user device to launch a digital distribution platform interface application; browse to the specified native application within the digital distribution platform interface application; install the specified native application; and then open the specified native application.

### Search Client Block Diagram

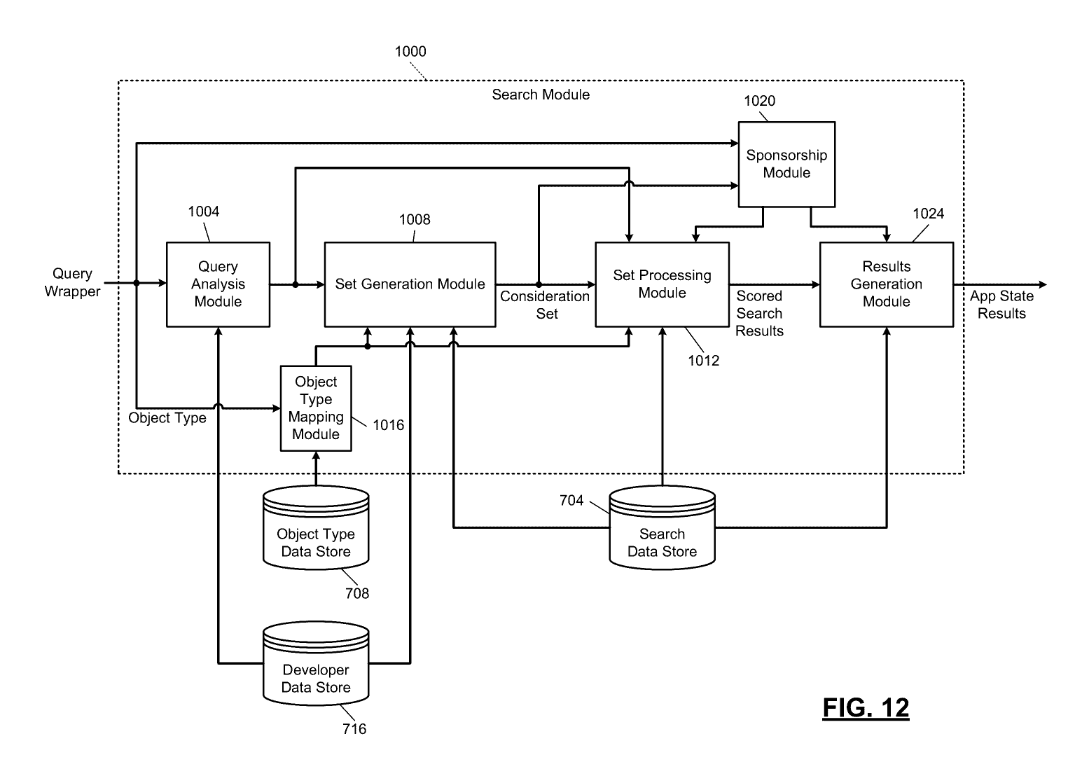

In FIG. 11, a functional block diagram of an example implementation of a search client 900 includes a user interface module 904. The user interface module 904 watches the displayed state of the user device and provides information about the displayed user interface elements to a focus identification module 906. In various implementations, the user interface module 904 may scrape the state of the user device to identify the types of user interface elements shown and their attributes, including position, transparency, etc.

The focus identification module 906 determines whether a multimedia object displayed on the user device appears to be focused—that is, to be the focus of the user's attention. When a focused object is identified, the user interface module 904 may be instructed to display a user interface element corresponding to that object, wherein the user interface element allows a user to search for apps or app states relevant to the type of object focused.

In other implementations, the user interface module 904 may display a user interface element for each multimedia object that matches certain criteria. For example only, every image or video that occupies more than a predetermined portion of the screen will be accompanied by a user interface element. Actuation by the user of a user interface element related to a first object indicates to the focus identification module that the first object has the user's focus.

A object type determination module 912 determines the type of the focused object and provides that object type to a query wrapper construction module 914. The object type determination module 912 may determine the type of the file based on an extension in the name of the file, based on metadata in the header of the file, based on an analysis of the structure of the header and/or body of the file, and/or from an object type indication from the operating system.

The query wrapper construction module 914 may also receive data from an installed app data store 916 and an active account data store 920. The installed app data store 916 may be populated from information provided by the operating system regarding which apps are installed. In other implementations, the operating system may simply be queried on demand by the query wrapper construction module 914 to determine what apps are installed.

The active account data store 920 tracks which accounts on the user device are active. This tracking may be based on information provided by the operating system and may require special permissions. The query wrapper construction module 914 constructs a query wrapper including the text query from the user and the object type from the object type determination module 912.

When the user's intent to search is identified, such as by the user clicking or tapping on one of the user interface elements, the query wrapper construction module 914 provides the query wrapper to a network communication module 924 for transmission to the search system 132 over a network, such as the network 408. In other implementations, the query wrapper may be sent even before a user request so that results can be rendered instantaneously if the user does make the search request.

The network communication module 924 receives results from the search system 132 and provides those results to a result presentation module 928. The result presentation module 928 presents the results to the user via the user interface module 904. In response to user selection of one of the results, the result presentation module 928 passes corresponding access mechanism information to an app state access module 932.

As described in more detail below, the app state access module 932 navigates to the specified app state of the specified app. Meanwhile a file management module 936 downloads or otherwise acquires a copy of the focused file. The file management module 936 may make a backup copy of the focused file in case changes are desired to be reverted and/or may make a temporary copy for use by the app. The file management module 936 passes identifying information (such as a pointer or link) about the focused file, or a temporary version of the focused file, to the app state access module 932. The app state access module 932 provides the identification of the focused file to the app state to allow the focused file to be operated on.

As described above, the search client 900 may be a standalone search client with permissions that allow user interface buttons to be overlaid on other apps in response to a multimedia object coming into focus. In other implementations, the search client 900 is code provide by an SDK library and integrated into a developer's app for use within that app.

### Search System Block Diagram

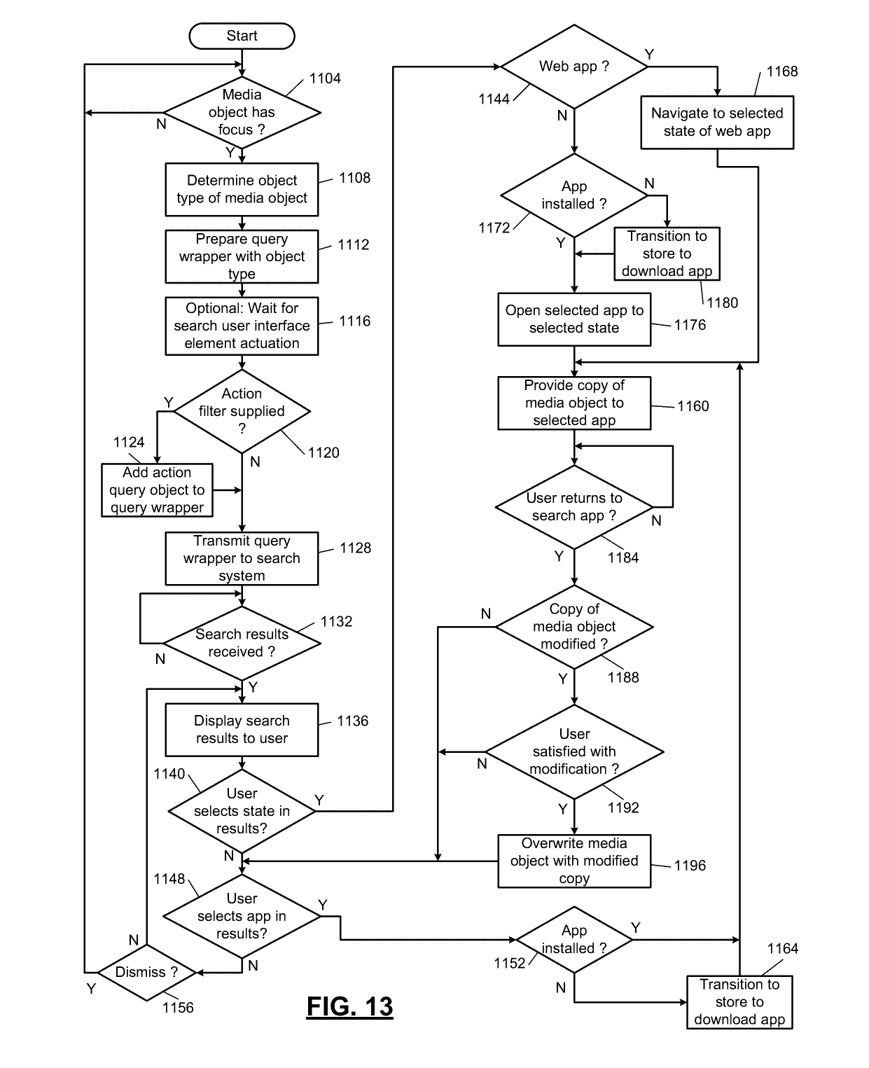

In FIG. 12, a functional block diagram of an example implementation of a search module 1000 includes a query analysis module 1004 that receives the query wrapper. The query analysis module 1004 analyzes a text query from the query wrapper in those implementations where a text query may be present and those circumstances where a text query is actually provided in the query wrapper.

For example, the query analysis module 1004 may tokenize the query text, filter the query text, perform word stemming, synonymization, and stop word removal. The query analysis module 1004 may also analyze additional data stored within the query wrapper. The query analysis module 1004 provides the tokenized query to a set generation module 1008.

The developer data store 716 may provide a query to the query analysis module 1004 when the query wrapper matches an entry in the developer data store 716. The stored query may include a list of actions that the developer wants to offer to users of the developer's app or may include a text string describing actions of interest.

The set generation module 1008 identifies a consideration set of application and app state records based on the query tokens. Some or all of the contents of the records of the search data store 704 may be indexed in inverted indices. In some implementations, the set generation module 1008 uses the APACHE LUCENE software library by the Apache Software Foundation to identify records from the inverted indices.

The set generation module 1008 may search the inverted indices to identify records containing one or more query tokens. As the set generation module 1008 identifies matching records, the set generation module 1008 can include the unique ID of each identified record in the consideration set. For example, the set generation module 1008 may compare query terms to the application name and application attributes (such as a text description and user reviews) of an app state record. The set generation module 1008 may also compare the query terms to application state information (such as application name and description and user reviews) of an app state record.

Further, in some implementations, the set generation module 1008 may determine an initial score of the record with respect to the search query. The initial score may indicate how well the contents of the record matched the query. For example, the initial score may be a function of the term frequency-inverse document frequency (TF-IDF) values of the respective query terms.

When no query is provided to the query analysis module 1004, the set generation module 1008 may simply identify app records and app state records based on the object type specified in the query wrapper.

A set processing module 1012 receives the unique IDs from the set generation module 1008 and determines a result score for some or all of the IDs. A result score indicates the relevance of an app or app state, given the tokenized query and context parameters, with a higher score indicating a greater perceived relevance. For example, other items in the query wrapper may act as context parameters. Geolocation data may limit the score of (or simply remove altogether) apps that are not pertinent to the location of the user device.

The set processing module 1012 may generate a result score based on one or more scoring features, such as record scoring features, query scoring features, and record-query scoring features. Example record scoring features may be based on measurements associated with the record, such as how often the record is retrieved during searches and how often links generated based on the record are selected by a user. Query scoring features may include, but are not limited to, the number of words in the search query, the popularity of the search query, and the expected frequency of the words in the search query. Record-query scoring features may include parameters that indicate how well the terms of the search query match the terms of the record indicated by the corresponding ID.

The set processing module 1012 may include one or more machine-learned models (such as a supervised learning model) configured to receive one or more scoring features. The one or more machine-learned models may generate result scores based on at least one of the app state ID scoring features, the record scoring features, the query scoring features, and the record-query scoring features.

For example, the set processing module 1012 may pair the search query with each ID and calculate a vector of features for each {query, ID} pair. The vector of features may include one or more record scoring features, one or more query scoring features, and one or more record-query scoring features. In some implementations, the set processing module 1012 normalizes the scoring features in the feature vector. The set processing module 1012 can set non-pertinent features to a null value or zero.

The set processing module 1012 may then input the feature vector for one of the application or app state IDs into a machine-learned regression model to calculate a result score for the ID. In some examples, the machine-learned regression model may include a set of decision trees (such as gradient-boosted decision trees). Additionally or alternatively, the machine-learned regression model may include a logistic probability formula. In some implementations, the machine-learned task can be framed as a semi-supervised learning task, where a minority of the training data is labeled with human-curated scores and the rest are used without human labels.

The machine-learned model outputs a result score of the ID. The set processing module 1012 can calculate result scores for each of the IDs that the set processing module 1012 receives. The set processing module 1012 associates the result scores with the respective IDs and outputs the most relevant scored IDs.

A sponsorship module 1020 receives the query wrapper and identifies apps and app states relevant to the query for which sponsorship has been indicated by an advertiser. For example, the sponsorship module 1020 may receive the consideration set from the set generation module 1008 and identify apps and app states within the consideration set for which sponsorship is desired. For example, the apps and/or app states in the consideration set that have corresponding sponsorship bids may be ranked. Those apps or app states with the highest initial score may be selected as sponsored links and provided to the set processing module 1012 for inclusion in the search results.

The set processing module 1012 may score the IDs provided by the sponsorship module 1020, and if the result score is high enough, output the sponsored apps or app states as part of the ordered search results. In other implementations, the sponsorship module 1020 may supply a tag with one or more of the IDs instructing the set processing module 1012 to include the IDs as sponsored results regardless of their result score.

A object type mapping module 1016 receives the object type designated in the query wrapper. The object type mapping module 1016 maps the object type contained in the query wrapper to an internal representation of object types for use by the set generation module 1008. Information for the mapping is stored in the object type data store 708. For example only, the object type from the query wrapper may be a MIME type, while the object types specified in the search data store 704 may be hexadecimal numbers proprietary to the search data store 704.

Further, an incoming object type may map to multiple internal (that is, internal to the search data store 704) object types, such as when an incoming object type of image/jpeg maps to jpg, jpe, and jpeg. In other implementations, the reverse mapping may be present. For example, the object type received from the query wrapper may simply be a plaintext string of the file's extension. Object type mapping module 1016 may therefore map the extension onto an object type consistent with the search data store 704. For example, “jpeg”, “jpg”, “jpeg”, and “jp2” extensions may all map to the same image/jpeg type recognized by the search data store 704.

In various implementations, the object type mapping module may implement an object type determination module (not shown) similar to the object type determination module 912 of FIG. 11. The implemented object type determination module may determine an object type in response to a received object header, a received object name (such as by the extension of the received object name), or a received copy of the object itself.

The mapped object types are provided to the set generation module 1008 and/or the set processing module 1012. The set generation module 1008 may filter app states based on the mapped filed types, as described in more detail below, before beginning to produce the consideration set. The set processing module 1012 uses the mapped object types to score the app states in the consideration set. For example, apps or app states having a higher confidence score corresponding to object types of interest may receive higher scores.

The sponsorship module 1020 may operate according to a variety of targeting parameters, which may be specified by an advertiser, such as by using the advertiser portal 412. For example, the advertiser may want to promote their app for use with a specific object type.

In another example, the advertiser may desire to have their app shown when similar apps are included in the consideration set. The similarity may be explicitly specified by the advertiser—for example, by listing apps similar to the advertiser's app. In other implementations, the search system 132 may include a similarity assessment module (not shown) that assesses how similar two apps are to each other. The similarity assessment module may determine the similarity between each of the apps in the consideration set with each of the potential sponsored apps. In various implementations, the advertiser may choose to have their app shown when the search query includes certain keywords or object types.

The sponsorship module 1020 may take into account whether a sponsored app is already installed on the user device from which the query wrapper was received. An advertiser may only be willing to pay a reduced price (or even nothing) to promote their app if their app is already installed on the user device.

The sponsorship module 1020 may select sponsored apps based on bid prices set by advertisers. An advertiser may set different bid prices to promote their app based on, for example, whether their app is already installed, how similar their app is to other apps in the result set, etc. The sponsorship module 1020 may choose, for inclusion in the ordered search results, apps having the highest bid prices for the present search.

A results generation module 1024 may choose specific access mechanisms from the application records and app state records selected by the set processing module 1012. The results generation module 1024 then prepares a results set to return to the user device. Although named “app state results,” some of the access mechanisms may be to a default state (such as a home page) of an app—these may be special cases of an app state record or simply an application record.

The results generation module 1024 may choose access mechanisms based on the operating system identity and version for the user device to which the results are being transmitted. For example, a script to download, install, open, and navigate to a designated state may be fully formed for a specific operating system by the results generation module 1024.

If the results generation module 1024 determines that none of the native access mechanisms are likely to be compatible with the user device, the search module 1000 may send a web access mechanism to the user device. If no web access mechanism is available, or would be incompatible with the user device for some reason (for example, if the web access mechanism relies on a JAVA programming language interpreter that is not installed on the user device), the results generation module 1024 may omit the result.

Blacklist information from the developer data store 716 may cause the set generation module 1008 to exclude apps or app states that match the blacklist criteria. A blacklist in the query wrapper may cause the set processing module 1012 to remove app records and/or app state records from the consideration set that match the criteria in the blacklist, or to set their score to a null value, such as zero.

When the developer data store 716 contains query information that corresponds to the present query (such as when a developer ID from the query wrapper matches an entry in the developer data store 716), the set generation module 1008 provides results based on that action. For example, the action may be specified as a plaintext query string. The plaintext query string may be provided to a query analysis module 1004 instead of directly to the set generation module 1008. For example, when the developer is able to provide their own preset search string, the search string may not already be parsed, tokenized, etc., and will therefore be provided to the query analysis module 1004.

### Search Client Operation

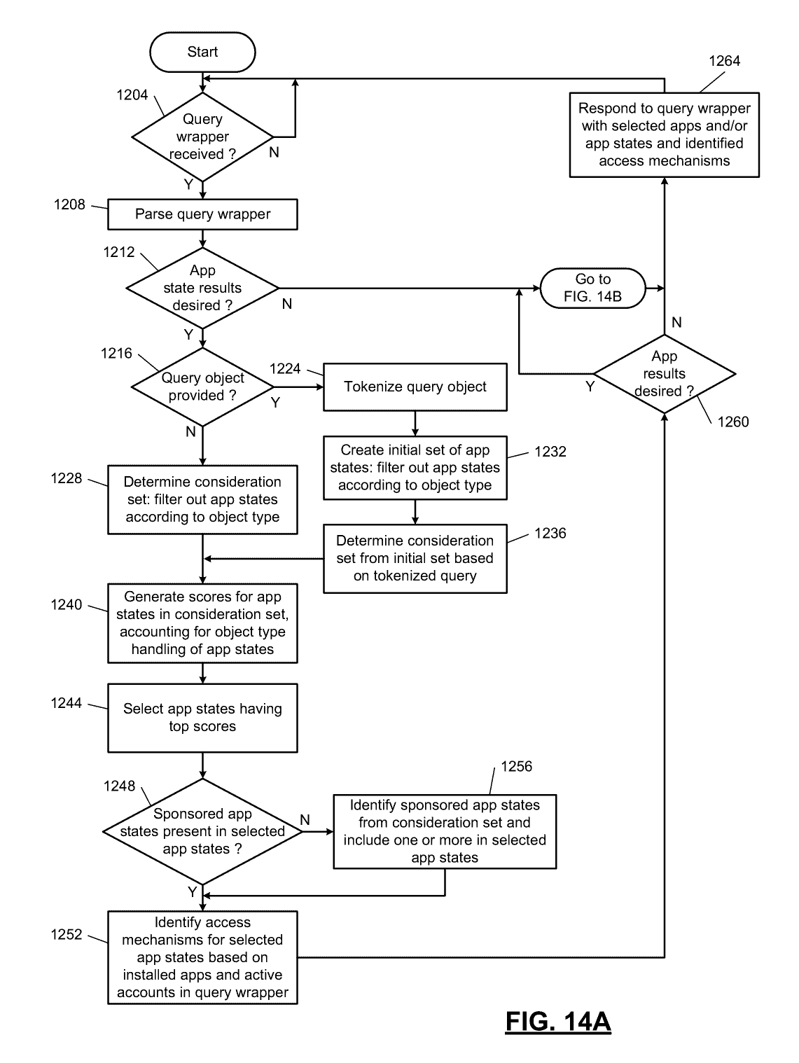

In FIG. 13, example operation of a search client begins at 1104, where control determines whether a media object has focus. If so, control transfers to 1108; otherwise, control remains at 1104. For example, an object may be determined to have focus when it is displayed full screen. If not displayed full-screen, the object or parent window may be determined to have focus when occupying more than a predetermined percentage (such as 40%) of the screen. However, if less than a predetermined percentage (such as 60%) of the object is visible, the object is determined not to have focus.

When multiple objects may possibly have focus, each object may receive a score based on the percentage of the object that is visible (more visible means higher score), the location of the object (higher on the screen means higher score), and size (larger means higher score). The object with the highest score is determined to have focus. A user interface element may be displayed near the focused object, or may be displayed for all objects. Selection of the user interface element corresponding to an object indicates the user's focus on that object.

At 1108, control determines an object type of the focused object, even if the object is not explicitly stored as a file. The determined object type may be a MIME type or media type, or may simply be a file extension. The MIME type or media type may be determined based on the file extension, a review of the header of the file, and/or based on an analysis of the header and/or body of the file. Control continues at 1112, where a query wrapper is prepared. As described above, the query wrapper will generally include the object type determined at 1108.

Control continues at 1116, where control may wait for the user to actuate a user interface element related to the search. Alternatively, control may immediately commission the search but wait to display results until the user has indicated their desire to search. At 1120, if an action filter has been supplied by the user, control transfers to 1124; otherwise, control transfers to 1128.

At 1124, controls adds the supplied action filter to the query wrapper as a query object and continues at 1128. At 1128, control transmits the query wrapper to a certain system. Control waits at 1132 until search results have been received from the search system and then transfers to 1136.

At 1136, control displays the search results to the user. At 1140, control determines whether a user selects a state from the results. If so, control transfers to 1144; otherwise, control transfers to 1148. Selecting of the app state may be indicated by the user touching, tapping, or clicking an area in which one of the results is displayed. Alternatively, a specific area is designated for each result and only uses a selection of that particular area will indicate a user selection of one of the states. For example, an underlined hyperlink may be clicked by the user while the surrounding text images and other metadata may be inert. In other implementations, selection of the surrounding text images and other metadata may indicate the user's intent to select the app in general.

At 1148, control determines whether the user has selected an app from the results. If so, control transfers to 1152; otherwise, control transfers to 1156. If, at 1152, the app is already installed, control transfers to 1160; otherwise, control transfers to 1164. At 1164, control transitions to a digital distribution platform store to download and install the app and control then continues at 1160. Returning to 1156, if the user has indicated a desire to dismiss the search results, control returns to 1104; otherwise, control returns to 1136.

At 1144, control determines whether the selected result corresponds to a web app. If so, control transfers to 1168; otherwise, control transfers to 1172. At 1168, control navigates to the selected state of the web app, which may simply be pointing a default web browser to a specific URL (uniform resource locator). Control then continues at 1160.

At 1172, control determines whether the app (which is not a web app and is therefore is assumed to be a native app) is installed. If so, control transfers to 1180; otherwise, control transfers to 1176. At 1180, control transitions to a digital distribution platform store to download and install the app and control then continues at 1176. At 1176, control opens the selected app to the selected state. It may be possible to open the selected app to the selected state using a single call, such as an “intent”. In other implementations, the app may be opened to a default state, such as a home screen, and then navigation commands can be sent to the selected app to arrive at the selected state. Control then continues at 1160.

At 1160, control makes a copy of the specified file and, at 1180, control provides a copy of the specified file to the selected app. For a native app, the copy may be provided by simply passing a reference or pointer. For a web app, the specified file may be uploaded. Control continues at 1184, where if the user returns to the search app, control transfers to 1188; otherwise, control remains at 1184. While in 1184, the user is interacting with the selected app or performing some other action not related to the search client.

At 1188, the user has returned to the search app and control determines whether the copy of the specified file has been modified. If so, control transfers to 1192; otherwise, control transfers to 1148. At 1192, control determines whether the user is satisfied with the modification. If so, control transfers to 1196; otherwise, control transfers to 1148. Control may determine that the user is satisfied with the modification by an affirmative response from the user. In other implementations, the user's dissatisfaction with the modification may be indicated by having actuated a back button to return to the search app without performing a save or other function in the selected app.

At 1196, control has determined the user was satisfied with the modification. Therefore, control overwrites the specified file with the modified copy and continues at 1148. In other implementations, the creation of a copy and the overwriting of the specified file may be omitted and the specified file itself may be provided to the selected app. Then, reversing of changes made by the selected app may be left to the selected app itself.

### Search System Operation

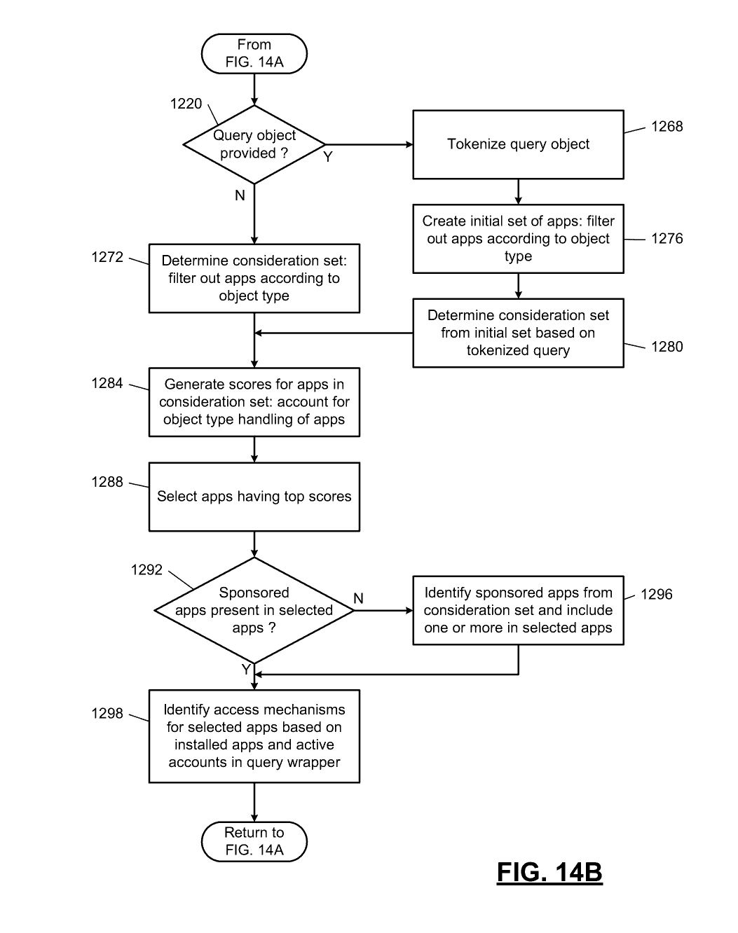

In FIG. 14A, example control of a search module for a file-type-based search begins at 1204. Note that FIGS. 14A-14B allow for search results to include only apps, only app states, or a combination of both. In various implementations, a search system may only support one or two of these options, instead of all three.

If a query wrapper is received at 1204, control transfers to 1208; otherwise, control remains at 1204. At 1208, control parses the query wrapper to determine whether app state results are desired. The query wrapper itself may have a determinative indication, or another source, such as a developer data store, may be consulted to determine whether app state results are desired.

At 1212, if app state results are desired, control transfers to 1216; otherwise, control transfers to 1220 in FIG. 14B. At 1216, control determines whether a query object was provided, either in the query wrapper, or by the developer data store based on identifying information in the query wrapper. If so, control transfers to 1224; otherwise, control transfers to 1228.

At 1224, control tokenizes the query object. Control continues at 1232 and creates an initial set of candidate app states by filtering out app states that definitively cannot handle the object type specified by the query wrapper. Alternatively, the initial set may be created by filtering out all app states except for app states that definitively can handle the object type specified by the query wrapper. In these implementations, if there are no apps that can definitively handle the object type, the initial set may be expanded to include apps that might be able to handle the object type.

Control continues at 1236 and determines a consideration set from within the initial set based on the tokenized query. Control continues as 1240. Returning to 1228, control determines a consideration set by filtering out app states according to object type, and may be performed similarly to 1232. Control then continues at 1240.

At 1240, control generates scores for each app state in the consideration set. The scores account for how confident the search system is that the corresponding app state can handle the specified object type. All other parameters being equal, an app state for which the confidence of handling of the object type is higher will receive a higher score.

At 1244, control selects those app states having the top scores in order to respond to the query. At 1248, control determines whether sponsored app states are present in the selected app states. If so, control transfers to 1252; otherwise, control transfers to 1256. At 1256, control identifies sponsored app states from the consideration set and includes one or more of those sponsored app states within the selected app states. If no sponsored app states appear in the consideration set, this may be an indication that no sponsored app states are relevant enough and therefore no sponsored app states will be included in the search results. Control then continues at 1252. Sponsored app states may be identified, such as by application of a sponsorship tag. The sponsorship tag may indicate to the search client that the app state should receive visual emphasis, whether by altering font, size, coloring, or position on the screen.

At 1252, control identifies access mechanisms for the selected app states. The access mechanisms may be based on information about apps installed on the user device and accounts that are active in the user device. This information may have been provided in the query wrapper.

For an app state that only has a single access mechanism, that access mechanism will be provided. For an app that is installed, the provided access mechanism will navigate to the appropriate state. If the app is not installed, an access mechanism will be included that first downloads the app and then navigates to the selected state. If it is unclear whether the app is installed, both of these access mechanisms may be included.

As a backup, a web access mechanism may be included for any selected app state for which a web access mechanism exists. In this way, if the user is not able to or does not want to install or use an app, the functionality can still be accessed via the web edition of the app.

Control continues at 1260, where if app results are also desired, control transfers to 1220 of FIG. 14B; otherwise, control continues at 1264. At 1264, control responds to the query wrapper with the selected apps and app states and their corresponding access mechanisms. Control then returns to 1204.

At 1220 (FIG. 14B), if a query object has been provided, control transfers to 1268; otherwise, control transfers to 1272. At 1268, control tokenizes the query object and continues at 1276 to create an initial set of apps by filtering out apps according to object type. This filtering may be performed similarly to how app state filtering is performed. Control continues at 1280, where a consideration set is determined from the initial set according to the tokenized query. Control continues at 1284.

Returning to 1272, control determines a consideration set by filtering out apps according to object type. Control continues at 1284. At 1284, control generates scores for apps in the consideration set, accounting for object type handling of the apps. Control continues at 1288, where control selects apps having the top scores.

Control continues at 1292 where, if sponsored apps are not present in the selected apps, control transfers to 1296; otherwise, control transfers to 1298. At 1296, control identifies sponsored apps from the consideration set and includes one or more sponsored apps in the selected apps. If the consideration set includes no sponsored apps, the results may be returned with no sponsored apps. Control then continues at 1298. At 1298, control identifies access mechanisms to open the selected apps. Control then returns to 1264 of FIG. 14A.

### General

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. An apparatus comprising:
a user interface module configured to selectively display a search user interface element to a user of the apparatus, wherein the search user interface element is associated with a multimedia object being presented to the user;
an object type determination module configured to determine type data for the multimedia object, wherein the type data indicates an object type of the multimedia object;
a query wrapper construction module configured to create a query wrapper based on the type data;
a network communication module configured to transmit the query wrapper to a search system and receive a result set from the search system, wherein the result set includes (i) identifying information of a first application state of a first application and (ii) a first access mechanism for the first application state, and wherein the identifying information includes at least one of text and an image;
a result presentation module configured to, in response to actuation by the user of the search user interface element, present the result set to the user, including (i) presenting the identifying information corresponding to the first application state and (ii) presenting a first user interface element corresponding to the first application state; and
an access module configured to, in response to actuation of the first user interface element by the user, (i) open the first application to the first application state according to the first access mechanism and (ii) provide the multimedia object to the first application state.

2. The apparatus of claim 1 wherein the type data includes one of (i) an Internet Assigned Numbers Authority media type and (ii) a MIME (Multipurpose Internet Mail Extensions) type.

3. The apparatus of claim 1 wherein the object type determination module is configured to determine type data for the multimedia object based on at least one of an extension of the multimedia object and a header region of the multimedia object.

4. The apparatus of claim 1 wherein the object type determination module is configured to set the type data for the multimedia object equal to an extension of the multimedia object.

5. The apparatus of claim 1 further comprising a focus identification module configured to:
determine whether the multimedia object is a focus of the user; and
direct the user interface module to display the search user interface element in response to determining that the multimedia object is the focus of the user.

6. The apparatus of claim 5 wherein:
the user interface module is configured to display search user interface elements each respectively associated with a plurality of multimedia objects; and
the focus identification module is configured to determine that the multimedia object is the focus of the user in response to user actuation of the search user interface element associated with the multimedia object.

7. The apparatus of claim 5 wherein the focus identification module is configured to selectively determine that the multimedia object is the focus of the user in response to the multimedia object occupying more than a predetermined percentage of a screen of the apparatus.

8. The apparatus of claim 7 wherein the focus identification module is configured to determine that the multimedia object is not the focus of the user in response to more than a second predetermined percentage of the multimedia object not being presently visible to the user.

9. The apparatus of claim 1 wherein the object type determination module is configured to determine the type data for the multimedia object after actuation by the user of the search user interface element.

10. The apparatus of claim 1 wherein the access module is configured to, in response to the first access mechanism being a web access mechanism, upload the multimedia object to a web server hosting the first application state.

11. The apparatus of claim 1 wherein the access module is configured to, in response to the first access mechanism being a native access mechanism, provide a location reference of the multimedia object to the first application state of the first application executing on the apparatus.

12. The apparatus of claim 1 further comprising a file management module configured to create a copy of the multimedia object prior to providing the multimedia object to the first application state.

13. The apparatus of claim 12 wherein the file management module is configured to overwrite the multimedia object with the copy in response to an indication by the user that a modification made to the multimedia object was unwanted.

14. The apparatus of claim 1 wherein:
the result set includes (i) identifying information of a second application state of a second application and (ii) a second access mechanism for the second application state; and
the access module is configured to, subsequent to modification of the multimedia object by the first application state and in response to actuation of a second user interface element by the user, (i) open the second application to the second application state according to the second access mechanism and (ii) provide the modified multimedia object to the second application state.

15. The apparatus of claim 1 further comprising:
an installed application data store that tracks apps installed on the apparatus, wherein the query wrapper construction module is configured to include information from the installed application data store in the query wrapper; and
an active account data store that tracks accounts registered with an operating system of the apparatus, wherein the query wrapper construction module is configured to include information from the active account data store in the query wrapper.

16. A search system comprising:
a set generation module configured to, in response to receiving a query from a user device, select a set of records from a plurality of records stored in a search data store, wherein:
each record of the plurality of records corresponds to an application,
the query includes information identifying a first object type, and
the set generation module is configured to select the set of records such that each record of the set of records includes metadata specifying an ability of the corresponding application to handle objects of the first object type;
a set processing module configured to assign a score to each record of the set of records, wherein:
the set processing module is configured to increase the score of a first record of the set of records in response to the metadata for the first record indicating higher certainty that the application corresponding to the first record is able to handle the first object type; and
a results generation module configured to transmit a results data structure to the user device, wherein:
the results data structure includes entries corresponding to records from the set of records that were assigned highest scores, and
each entry of the results data structure includes an access mechanism configured to allow a user of the user device to access the respective application.

17. The search system of claim 16 wherein:
each record of the plurality of records corresponds to a state of an application; and
for each entry of the results data structure, the access mechanism is configured to allow the user of the user device to access a respective state of the respective application.

18. The search system of claim 17 wherein each record of the set of records includes metadata specifying the ability of the respective state of the respective application to handle the first object type.

19. The search system of claim 17 wherein:
the query includes an indication of a first action the user of the user device desires to perform on a first object having the first object type; and
the set generation module is configured to select the set of records such that each record of the set of records includes metadata indicating an ability of the respective state of the respective application to perform the first action.

20. The search system of claim 16 wherein:
the query includes an indication of a first action the user of the user device desires to perform on a first object having the first object type; and
the set generation module is configured to select the set of records such that each record of the set of records includes metadata indicating an ability of the respective application to perform the first action.

21. The search system of claim 20 wherein:
the query includes a text string identifying the first action; and
the set processing module is configured to calculate the score of the first record based on a term frequency-inverse document frequency comparison of the text string to text metadata of the first record.

22. The search system of claim 21 further comprising a query analysis module configured to parse the text string into tokens, wherein the set processing module is configured to calculate the score of the first record based on a term frequency-inverse document frequency comparison of the tokens to text metadata of the first record

23. The search system of claim 16 wherein the first object type specifies one of (i) an Internet Assigned Numbers Authority media type and (ii) a MIME (Multipurpose Internet Mail Extensions) type.

24. The search system of claim 16 further comprising an object type mapping module configured to map from a first domain to a second domain, wherein the first domain includes a list of object types provided by queries, and wherein the second domain includes a list of object types recognized by the search data store.

25. The search system of claim 16 further comprising an object type mapping module configured to determine the first object type based on at least one of an extension of an object and a header region of the object, wherein the query includes the at least one of the extension of the object and the header region of the object.

26. The search system of claim 16 wherein:
the query includes information regarding at least one of applications installed on the user device and user accounts active on the user device; and
the set processing module is configured to at least one of (i) increase the score of the first record in response to the information indicating that the application corresponding to the first record is installed on the user device and (ii) increase the score of the first record in response to the information indicating that one of the user accounts active on the user device is associated with the application corresponding to the first record.
